(19) United States
(12) Patent Application Publication
(10) Pub. No.: US 2026/0003649 A1
(43) Pub. Date: Jan. 1, 2026

(54) TECHNIQUES FOR USER INTERFACE DATA MANAGEMENT

(71) Applicant: Oracle International Corporation, Redwood Shores, CA (US)

(72) Inventors: Abishek Murali Mohan, Sammamish, WA (US); Alaa Shaker, Seattle, WA (US); Bora Vuth, Bellevue, WA (US); Javier Perez, Miami, FL (US); Gaurav Kukreja, Round Rock, TX (US)

(73) Assignee: Oracle International Corporation, Redwood Shores, CA (US)

(21) Appl. No.: 18/757,867

(22) Filed: Jun. 28, 2024

(51) Int. Cl. G06F 9/451

(52) U.S. Cl. CPC G06F 9/451

(57) ABSTRACT

The disclosed systems, methods and computer readable media relate to a centralized gateway. The gateway may receive at least a portion of a first user interface (UI) configuration file that specifies a first set of one or more data sources for first data values to be used in rendering a first page at a first UI. The gateway may receive at least a portion of a second UI configuration file that specifies a second set of one or more data sources for second data values to be used in rendering a second page at a second UI. The gateway serves as a common entry point for the first and second sets of one or more data sources. The gateway may direct different requests to the respective data sources for the data values to be used in rendering the respective pages.

### BACKGROUND

In recent years, the development of cloud-based user interface (UI) platforms has witnessed remarkable advancements, particularly in the realm of plugin architecture and rendering techniques. Traditional micro-frontend architectures have empowered service teams in building, testing, and deploying their UI components independently. This approach supports plugin development by providing tooling, libraries, and processes aimed at enhancing developer productivity and ensuring a consistent user experience.

While this decentralized model initially offered flexibility and autonomy to service teams, it soon revealed its limitations. The current UI development process is largely a manual process and platform specific; plugins cannot easily be ported to different platforms. Issues such as inconsistent user experiences, fragmented designs, and redundant efforts across plugins emerged as significant hurdles, impeding scalability and standardization efforts across the platform. The implementation of platform-wide enhancements or the introduction of new features often leads to prolonged development cycles and laborious coordination efforts, highlighting the need for innovative solutions capable of addressing these challenges effectively. Each team independently implementing similar functionalities leads to bloated dependencies and inefficient resource usage.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Techniques provided herein are directed to a MAUI (Metadata-and API-driven User Interface) platform that revolutionizes plugin development and UI rendering (e.g., within cloud-based UI platforms). The MAUI platform utilizes a data gateway (also referred to as a “console gateway” to handle common activities such as logging, metrics, caching, data retrieval and aggregation, and transformation of data to ensure uniformity. Rate limiting, retries, error handling, authorization, authentication, and the like may also be handled uniformly due to the centralized approach of the disclosed data gateway. By utilizing the disclosed data gateway, data may be cached such that retrieved data may be utilized across user interfaces, reducing the number of application programming interface calls made to populate the user interfaces with data. Middleware may be used to inject additional functionality into the data gateway. Data management for any user interface rendered by MAUI may use the same data gateway.

At least one embodiment is directed to a method. The method may comprise receiving, by a console gateway, at least a portion of a first user interface (UI) configuration file that specifies a first set of one or more data sources for first data values to be used in rendering a first page at a first user interface. The method may comprise receiving, by the console gateway, at least a portion of a second UI configuration file that specifies a second set of one or more data sources for second data values to be used in rendering a second page at a second user interface. In some embodiments, the console gateway serves as a common entry point for the first set of one or more data sources and the second set of one or more data sources. The method may comprise directing, by the console gateway, a first request for the first data values to be used in rendering the first page to the first set of one or more data sources. The method may comprise directing, by the console gateway, a second request for the second data values to be used in rendering the second page to the second set of one or more data sources.

In some embodiments, the console gateway is configured to perform common functions for requests for data values to a plurality of data sources, the common functions comprising at least one of: authentication, authorization, logging, metrics generation, caching, data aggregation, data transformation, rate limiting, retry, or error handling.

In some embodiments, the console gateway is configured to perform the common functions in a uniform fashion across the plurality of data sources.

In some embodiments, the console gateway is further configured to perform an application-specific function for a request for data values from a data source for rendering a particular page for a particular application.

In some embodiments, the console gateway is configured to implement a centralized cache for a plurality of data sources. In some embodiments, implementing the centralized cache comprises: 1) storing, by the console gateway at the centralized cache, the first data values obtained from the first set of one or more data sources for rendering the first page, and 2) retrieving, by the console gateway from the centralized cache, the first data values obtained for rendering the first page, the first data values being used to render a third page at a third user interface based on a third UI configuration file.

In some embodiments, the first UI configuration file specifies an application programming interface, and the first data values to be used in rendering the first page at the first user interface are requested by the console gateway using the application programming interface specified by the first UI configuration file.

In some embodiments, the console gateway transforms the first data values to be used in rendering the first page at the first user interface prior to the first data values being rendered at the first page at the first user interface, and the first data values are transformed according to a transformation rule specified by the first UI configuration file.

In some embodiments, the first data values are aggregated with additional data values obtained by the console gateway, and the first data values are aggregated with the additional data values based at least in part on an aggregation rule specified by the first UI configuration file.

In some embodiments, the method comprises filtering, by the console gateway, the first data values obtained by the console gateway, wherein the first data values are filtered based at least in part on filtering data specified in the first UI configuration file.

In some embodiments, the first UI configuration file comprises at least one of: an application programming interface with which the first data values may be obtained, a transformation rule for transforming the first data values obtained, an aggregation rule for aggregating the first data values with one or more additional data values, or filtering data defining a number of filters with which the first data values are filterable.

In some embodiments, functionality of the console gateway is extended by one or more middleware components. In some embodiments, the one or more middleware components are provided by an application executing at a client device, the application being extended by a software plugin.

In some embodiments, the console gateway operates as a data access layer of a Model-View-ViewModel computing architecture. The console gateway may be invoked by a model component of the Model-View-ViewModel computing architecture.

In some embodiments, the console gateway queues the first request and the second request and invokes a corresponding worker process to handle each queued request.

In some embodiments, performing a modification corresponding to functionality of the console gateway applies the modification for all subsequent requests.

In some embodiments, the console gateway instantiates a worker process, and the worker process is configured by the console gateway to perform at least one of: authentication, data transformation, data aggregation, pagination, caching, or retries. In some embodiments, the console gateway manages a lifecycle of the worker process.

In some embodiments, the method may further comprise caching the first data values in a local cache, determining, by the console gateway, that the second data values to be presented at the second user interface includes the first data values that are cached in the local cache, and obtaining, by the console gateway from the local cache, at least a portion of the second data values to be presented at the second user interface.

In some embodiments, a console component is disclosed that comprises one or more processors and one or more memories storing computer-executable instructions that, when executed by the one or more processors, causes the one or more processors to perform the method(s) disclosed herein.

In some embodiments, a system is disclosed that comprises one or more processors and one or more memories storing computer-executable instructions that, when executed by the one or more processors, causes the one or more processors to perform the method(s) disclosed herein.

In some embodiments, a non-transitory computer-readable storage medium storing computer-executable instructions that, when executed with one or more processors of a computing device, causes the computing device to perform the method(s) disclosed herein.

### BRIEF DESCRIPTION OF THE DRAWINGS

FIG. 1 which is a block diagram illustrating a high-level solution diagram contrasting the conventional method of UI rendering with the new approach utilizing a rendering plugin, according to at least one embodiment.

FIG. 2 illustrates a block diagram illustrating system components and constructs of a Metadata and API driven User Interface (MAUI) platform, according to at least one embodiment.

FIG. 3 is a block diagram illustrating a method for generating a merged configuration file for rendering a page, according to at least one embodiment.

FIG. 4 illustrates an example template configuration file, according to at least one embodiment.

FIG. 5 illustrates an example input configuration file, according to at least one embodiment.

FIG. 6 illustrates an example merged configuration file, according to at least one embodiment.

FIG. 7 is a block diagram illustrating components of an example Rendering Engine 700, according to at least one embodiment.

FIG. 8 illustrates a block diagram depicting example interactions between a Rendering Engine and a Component Builder of a web application environment, according to at least one embodiment.

FIG. 9 illustrates a block diagram illustrating example components of a Data Gateway within a web application environment, according to at least one embodiment.

FIG. 10 is a block diagram illustrating an example process for authoring, hosting, and delivering configuration files, according to at least one embodiment.

FIG. 11 is a block diagram illustrating an example method for routing web page requests, according to at least one embodiment.

FIG. 12 is a block diagram depicting an example method for selecting a plugin to process a given request, according to at least one embodiment.

FIG. 13 is a sequence diagram depicting an example method for processing a request by various components associated with a Rendering Plugin, according to at least one embodiment.

FIG. 14 is a block diagram illustrating an example method, according to an embodiment.

FIG. 15 is a block diagram illustrating another example method, according to an embodiment.

FIG. 16 is a block diagram illustrating yet another example method, according to an embodiment.

FIG. 17 is a block diagram illustrating one pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating another pattern for implementing a cloud infrastructure as a service system, according to at least one embodiment.

FIG. 20 is a block diagram illustrating another pattern for implementing a cloud infrastructure as a service system, according to at least one embodiment.

FIG. 21 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### Introduction

The current user interface (UI) framework in use for web applications, built on a micro-frontend federated platform, has been instrumental in allowing service teams to independently develop, test, and deploy their UI components. This framework, while successful in accelerating the development and scaling of web interfaces, has encountered significant challenges. Notably, the decentralized nature of UI development has led to inconsistencies in user experience (UX) and implementation quality. Making product-wide improvements or introducing new features across the numerous independently developed plugins has proven to be slow and costly. This fragmented approach also results in redundancy, where similar functionalities are developed multiple times across different plugins, leading to bloated dependencies and increased operational burden.

To address these issues, a new Metadata- and API-driven User Interface (MAUI) platform and federation model is proposed. This model shifts the responsibility of UI development from manual plugin creation to a more streamlined, configuration-driven approach. Service teams may now declaratively define the appearance and behavior of their UIs through configuration files, which are then interpreted and rendered by a centralized platform at runtime.

This approach aims to standardize UX, simplify the process of seamlessly implementing product-wide updates, and significantly improve performance by reducing the size and redundancy of UI components.

The MAUI framework allows service teams (or other UI providers) to declaratively define the appearance and behavior of their user interfaces using configuration files (herein referred to as “config files”). These config files, authored in a human-readable format, specify the layout, components, and interactions of the UI. By way of example, a template configuration file (a “template config”) may be used to provide an abstraction of a given UI/page with place holders to be filled in. A separate file, an input configuration file (an “input config”) may be used to declare the business logic of the UI including where to obtain data to be presented at the UI, how the data is processed, and actions the user can take with the user interface. The input configuration file may specify how to construct a data set in memory and a set of actions and triggers that alter that data set. Once these configurations are defined, a rendering executing as part of a plugin of a web application executing at a client device dynamically interprets and renders the UI at runtime. This declarative approach significantly reduces the need for manual coding, thereby enhancing developer productivity and ensuring a consistent user experience across the application. The MAUI framework is particularly effective for handling common UI patterns such as listing pages, detail pages, and form pages, making it an ideal solution for applications with repetitive UI requirements.

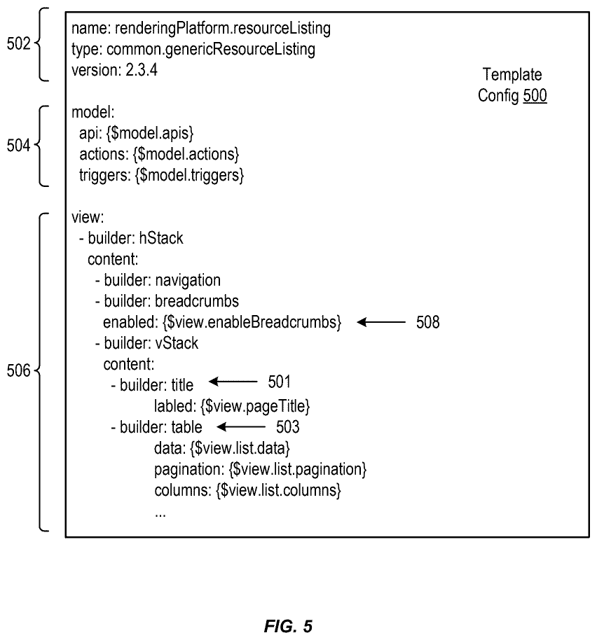

As a non-limiting example, for a resource listing page, a template configuration file may indicate that the page has a title, a description, breadcrumbs, a table, a possibility of filters (but not which ones), a possible action bar (but not which actions), etc., but not what content to render or features to enable. An example of such a template configuration file is provided in FIG. 5. An input configuration file for the resource listing page may indicate where to get the data from, how to transform values or join with other data, what filters can be applied, what actions can be taken, etc., but not the specific component that is used to provide the list. The list could be rendered as a table, a list, or even a collection of tiles.

In conventional cloud-based UI platforms, the direct instantiation of visual components for rendering forms and user interfaces presents challenges in flexibility and adaptability. Traditionally, UI rendering engines have been tightly coupled with specific component libraries, making it challenging to switch between different libraries or update the UI components without significant rework. The reliance on specific component libraries and design languages results in rigid architectures that hinder seamless transitions between different UI environments. Moreover, the lack of standardized methods for component instantiation and styling exacerbates complexities in platform maintenance and evolution. Without a flexible abstraction layer, the rendering engine would need to be explicitly programmed to handle each type of component and its associated styling, leading to increased complexity and reduced modularity. Thus, a need arises for an innovative solution that decouples the rendering engine from specific component libraries, facilitating dynamic component instantiation and styling.

A Component Builder of the MAUI platform enables the rendering engine to dynamically instantiate appropriate components at runtime, without knowledge of the specific component library or design language it is using. This component abstraction layer standardizes component instantiation processes, fostering adaptability and scalability across diverse UI environments. By mapping abstractions of component intents to concrete implementations at runtime, the Component Builder may ensure seamless transitions between different component libraries and design languages, promoting platform flexibility and evolution.

In traditional plugin-based web applications, individual plugins often communicate directly with backend APIs, resulting in fragmented data management and increased complexity in handling data operations. Each plugin must implement its own data aggregation, transformation, persistence, and caching mechanisms, leading to redundancy and inefficiencies. Moreover, managing error handling, instrumentation, and context-specific data becomes cumbersome, particularly as the number of plugins grows. This fragmented approach can also lead to inconsistent data handling practices, reduced performance due to redundant data fetching, and a higher likelihood of integration issues.

To address these challenges within the MAUI environment, a new data access layer, referred to as the “Data Gateway”, is provided. The Data Gateway centralizes and standardizes data communication between plugins and backend services. By abstracting the data handling logic from the plugins, it enables a more efficient and coherent data management strategy. Teams may specify their data requirements in the input configuration, which the rendering engine passes to the Data Gateway for fulfillment. This centralized approach simplifies data operations, improves data consistency, and enhances the overall performance of the application.

This novel approach to data management in plugin-based web applications decouples data handling logic from individual plugins and centralizing it within a unified access layer. This abstraction layer standardizes data operations and provides middleware capabilities to extend its functionalities. The use of data providers and a request queue allows for efficient management of data operations, including retries, pagination, caching, and aggregation, which are often cumbersome to implement at the plugin level.

The integration of these systems constitutes a robust and flexible framework for dynamic UI rendering. This architecture not only improves developer productivity and application maintainability but also guarantees a consistent and high-quality user experience. By separating the UI logic from the implementation details, the system supports scalable and efficient development of complex web applications.

The disclosed techniques for MAUI offer several key technical advantages over conventional platforms. Firstly, it standardizes UX across different interfaces, ensuring a consistent and high-quality user experience. This standardization is achieved by defining generic page templates and components that can be reused across different configurations. Additionally, the platform facilitates easier and more reliable implementation of product-wide improvements. Since the configuration files are centrally managed and interpreted at runtime, updates to templates or components can be propagated without requiring extensive manual changes to individual plugins.

The new techniques enhance performance by reducing the overall size of UI bundles and eliminating redundant implementations. By centralizing the UI logic and leveraging a low-code solution, the platform decreases the memory footprint and improves load times, thereby delivering a more responsive and efficient user experience.

By providing a clear separation between the definition of UI components and their rendering, this methodology enables service teams to focus on defining UI requirements without being encumbered by implementation details. This shift to a configuration-driven approach reduces the time, effort, and expertise required for service teams to build and maintain their UIs, further accelerating development cycles and enabling rapid rollout of new features.

The disclosed Component Builder introduces a novel abstraction layer that decouples the rendering engine from specific component libraries and design languages. This abstraction layer uses a builder pattern to provide a uniform contract for configuring and rendering components at runtime. By leveraging application-specific implementations, the Component Builder maps abstract component intents to concrete component instances, allowing the rendering engine to instantiate and render the appropriate component without being aware of or depending on the underlying library/framework used to generate the concrete component.

The disclosed Component Builder standardizes the process of component instantiation and configuration across different libraries, ensuring consistent and high-quality UX regardless of the component source. It simplifies the process of updating or swapping component libraries, as the rendering engine does not need to be modified to accommodate new components. This results in improved performance, reduced redundancy, and a smaller memory footprint, as the system can efficiently manage component rendering and transitions between different design languages.

The disclosed Data Gateway offers several technical advantages over conventional techniques by providing a unified data access layer that abstracts the complexities of data communication, aggregation, transformation, and caching. One significant advantage is the ability to share data sources and leverage client-side caching optimizations. This reduces redundant data fetching, as data retrieved by one plugin can be reused by others, leading to improved performance and reduced latency. Cross-page and cross-session caching capabilities further enhance efficiency by maintaining data consistency across different views and user sessions.

Another key advantage is the robust error handling and instrumentation provided by the Data Gateway. By centralizing these functionalities, the Data Gateway ensures consistent and reliable error management, logging, metrics collection, and analytics across all plugins. This centralized approach not only simplifies the implementation for individual plugin teams but also provides a holistic view of data operations, facilitating easier debugging and performance monitoring.

The disclosed Data Gateway provides significant improvements over conventional methods by reducing redundancy and ensuring consistent data handling practices. The Data Gateway's ability to handle multiple backend APIs through a common interface and middleware injections further enhances flexibility and adaptability. It allows for seamless integration with various backend services and supports complex data operations without burdening individual plugins with intricate data management logic. By centralizing and standardizing data operations, the Data Gateway enhances the scalability, performance, and maintainability of web applications within the MAUI environment, providing a robust foundation for efficient data-driven UI rendering.

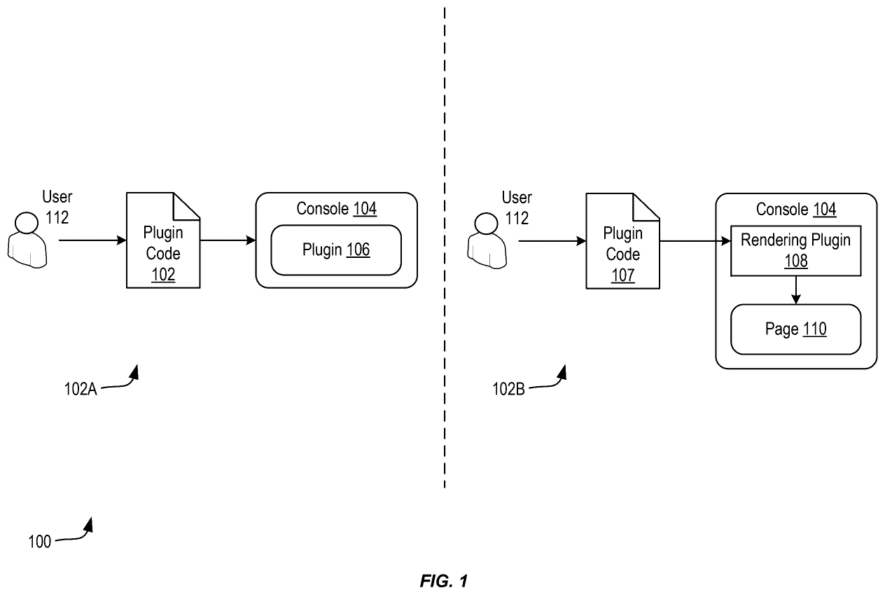

Moving on to FIG. 1, which is a block diagram illustrating a high-level solution diagram contrasting the conventional method of UI rendering with the new approach utilizing a rendering plugin, according to at least one embodiment. The figure is divided into two halves: the left half (depicted by the dashed line) represents the traditional method, while the right half depicts the new solution incorporating the plugin rendering engine.

A conventional rendering approach is depicted at 102A, where a user 112 may provide plugin code 102. The plugin code 102 may then be executed within a console 104 to extend functionality of Console 104 without modifying the core code that, when executed, implements the Console 104. Plugin 106 may be a sandboxed mini-application that runs seamlessly within the Console 104 (e.g., an example of the Oracle Cloud Infrastructure (OCI) Console). Plugin 106 may represent a unit of ownership that mirrors a service team and/or a domain of a cloud computing environment. In some embodiments, plugin 106 may be configured to render all (or some subset) of pages that represent one or more OCI services. By way of example, plugin 106 may be configured to manage one or more user interfaces/pages provided in response to a request for a given page. Management of the one or more user interfaces/pages may include determining the format of the page with which the user interface is presented, implementing the look and feel of each of the components of the user interface, as well as managing the retrieval and presentation of any suitable data to be presented at the user interface. This conventional method may require each plugin to be independently built, tested, and maintained.

The conventional approach depicted at 102A presents a number of drawbacks with respect to managing user interfaces presented at Console 104. For example, because the rendering of pages/user interfaces are individually handled by different plugins, the pages may have different looks and/or inconsistent behavior with some pages being of higher quality than others. This caused a disjointed user experience. Additionally, if changes were desired from a system wide perspective such as uniformly changing the look and feel of UI elements presented at various user interfaces, each individual plugin would be required to be updated to implement the change. Similarly, any changes to the format of the page or data management techniques would require corresponding changes to be made to the plugin code 102. These types of changes would require an updated plugin to be installed in Console 104 to be effectuated. Thus,

On the right side of FIG. 1, at 102B, an improved method is depicted. A user 112 may provide plugin code 107 for execution to extend the functionality of Console 104. Plugin code 107, when executed, may implement rendering plugin 108. The rendering engine 108 may be configured to render any suitable number of pages (e.g., page 110) at which any suitable number of corresponding user interfaces may be presented. The rendering engine 108 may dynamically generate these pages (e.g., page 110) based on one or more configuration files. By way of example, the rendering engine 108 may utilize configuration files that define the layout and components of the page 110 as well as the behavior and data management aspects of the page 110. By using these configuration files, changes to layout, styling, or data management can be made by providing a new configuration file that indicates the changes without requiring modifications to the rendering plugin 108, supporting the dynamic adaptation of user interfaces based on different devices or user preferences. These changes can be made at runtime based at least in part on swapping out one or more configuration files such that the changes to page 110, for example, may be implemented from one request to the next, without having to update and reinstall rendering plugin 108 at Console 104. In some embodiments, rendering plugin 108 may be used in conjunction with one or more individual plugins (e.g., plugin 106) to manage a portion of the total number pages/user interfaces provided via Console 104. This may enable migration toward the use of rendering plugin 108 to be conducted in a piece meal fashion, over time, reducing the risk of runtime errors while migrating to using the rendering plugin 108.

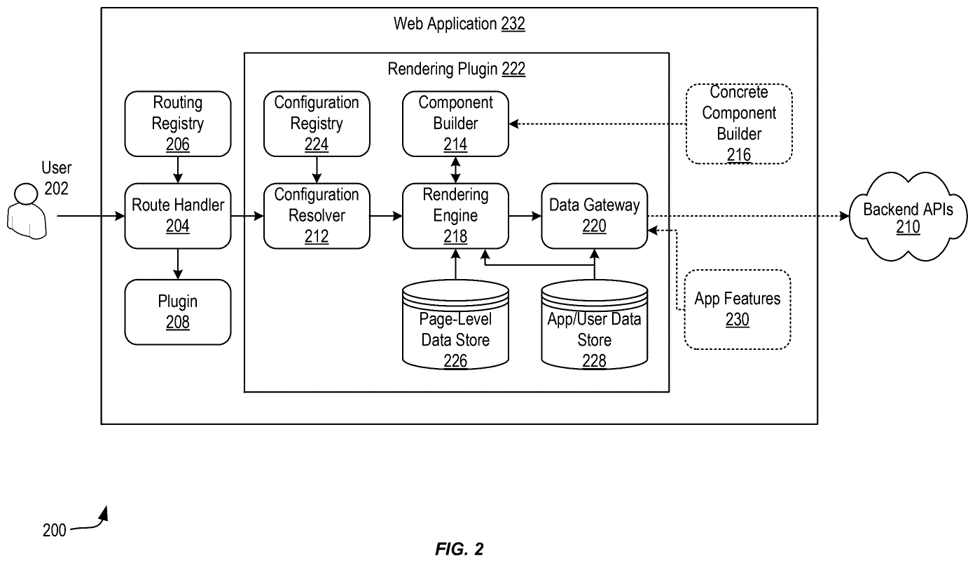

FIG. 2 is a block diagram 200 illustrating example system components and constructs of a Metadata and API driven User Interface platform, according to at least one embodiment.

In some embodiments, the web application environment 200 may include various components for dynamically rendering user interfaces based on one or more configuration files. The components may work together to provide a modular and flexible system for developing and deploying user interfaces.

In some embodiments, the web application environment 200 may include a User 202 who may interact with the application. The user action may trigger requests that are processed by the Route Handler 204. The Route Handler 204 may manage incoming user requests (e.g., page requests) and direct them to the appropriate components, which may be the Original Plugin 208 or the Rendering Plugin 222, based on predefined rules which may be managed by the Routing Registry 206. By way of example, the Routing Registry 206 may be an extension of a plugin registry of web application 232 (e.g., a web application executing on a user device, not depicted). The Routing Registry 206 may be configured to maintain a mapping of Uniform Resource Locator (URL) paths (e.g., “page/7” from URL: “http://examplepage.com/page/7”) to corresponding intents (e.g., “intent.opa.instances.listing”). An “intent” may be an object that represents an abstraction of operations such as navigations or actions. An intent can be implicit or explicit. Implicit intents may not specify specific components to be run (e.g., Plugin 208 versus Rendering Plugin 222) but may include enough information for the Route Handler 204 to determine the appropriate component to run for that intent (e.g., Plugin 208 versus Rendering Plugin 222). Plugin 208 may be an example of plugin 106 of FIG. 1, which is configured to manage aspects of a given page in response to a user request for that page. Rendering Plugin 222 may be an example of rendering plugin 108 of FIG. 1 which may be configured to render a variety of pages in response to corresponding user requests and based at least in part on one or more configuration files.

In some embodiments, the intent may be explicit, where the URL is mapped to an intent that is associated with a particular component (e.g., Plugin 208 or Rendering Engine 222) which is then invoked to handle the rendering of the requested page. The Route Handler 204 may be configured to route requests according to the explicit component indicated in the intent obtained from Routing Registry 206 of a given URL path, or the Route Handler 204 may be configured with a mapping to of intents to either an individual plugin (e.g., Plugin 208) or the Rendering Plugin 222. If routed to the Plugin 208, the rendering of the page may be performed entirely by the Plugin 208 in a manner similar to the approach discussed at 102A of FIG. 1.

Alternatively, when the intent is mapped to the Rendering Plugin 222, or the Rendering Plugin 222 is explicitly identified by the intent, the Route Handler 204 may route the request to the Configuration Resolver 212 (also referred to as a “Config Resolver”). Routing the request may include providing the intent (e.g., intent.opa.instances.listing) to the Configuration Resolver 212 for processing.

The Configuration Resolver 212 may be a runtime component configured to receive intents and obtain and/or prepare one or more configuration files to be utilized for rendering. The Configuration Resolver 212 may perform several functions, including taking an intent as input, fetching a corresponding input configuration file and/or template configuration file (e.g., from the Configuration Registry 224), applying runtime validation rules to the configuration file(s), and merging the input configuration and template configuration to produce a merged configuration file. An input configuration file and template configuration file may be used to declaratively define how a corresponding UI is to look, behave, and function. The Configuration Registry 224 may be a central repository that may store any suitable combination of input and template configuration files, ensuring that configurations are centrally managed and accessible.

In some embodiments, at least some functionality of Configuration Resolver 212 may be provided at a server computer and the merged configuration file may be generated at the server in advance of a request for the corresponding page. In some embodiments, the merged configuration file may be provided by the server computer to a client device (e.g., a device on which Rendering Plugin 222 executes) at any suitable time and stored in Configuration Registry 224 for later retrieval by Configuration Resolver 212.

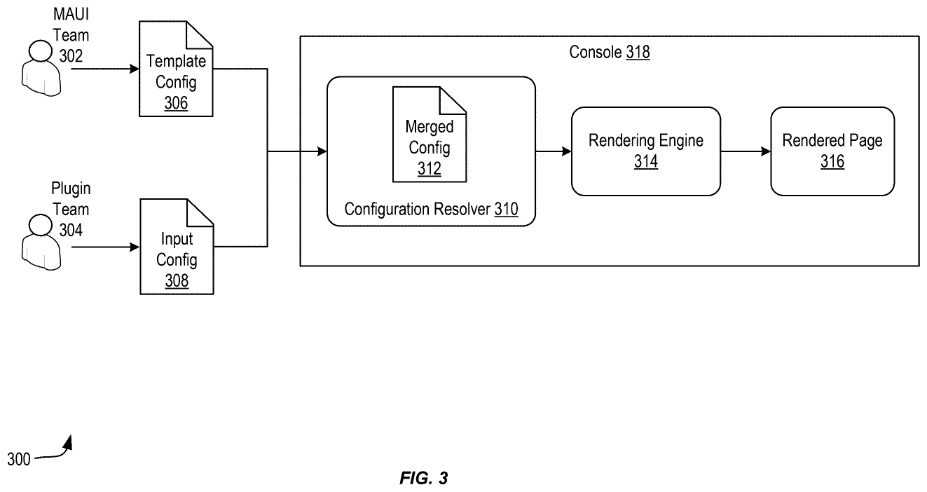

FIG. 3 is a block diagram illustrating an example method 300 for generating a merged configuration file, according to at least one embodiment.

In some embodiments, a MAUI Team 302 (e.g., a cloud service provider such as a team responsible for managing the Rendering Plugin 222 of FIG. 2) a Plugin Team 304 (e.g., a cloud service provider such as a service team responsible for the page 316) may be responsible for creating a template configuration file (e.g., Template Config 306) and an input configuration file (e.g., Input Config 308), respectively. In some embodiments, the template configuration file may be generated by a third cloud service provider (e.g., a service team different than the MAUI Team 302 and Plugin Team 304. A template configuration file may be an abstraction of a given page with placeholders to be filled in. A template configuration file may be used to define the page layout/format and the components to be rendered with one or more data placeholders to be filled in (e.g., by data provided in a corresponding input configuration file). Generally, a template configuration file may define what gets rendered on a given page, but it does not define how the rendering is to be performed. A template configuration file may be incomplete in the sense that it may not be used by itself to render a page. An input configuration file may be used to provide data values and/or data sources for populating the set of data placeholders of the template configuration file. In some embodiments, the data values and/or data sources may be transformed before populating the data placeholders of the template configuration file. An input configuration file may be used to provide business logic that defines from where and how data to be presented at the page is to be obtained, the actions a user may take, and the like. In some embodiments, an input configuration file may be used to construct a data set in memory and defines a set of actions and triggers that may alter that data set. An input configuration file may not be used by itself to render a page because it does not include the presentation layer that is defined using a template configuration file. The user of both the template configuration file and the input configuration file for a given page is to separate what components get rendered on the page from the specific manner in which the components of the page are rendered. By using separate configuration files, updates to the pages formatting/layout may be performed at runtime simply by swapping one template configuration file for another.

At runtime (e.g., in response to receiving an intent corresponding to a page), the Configuration Resolver 310 (an example of the Configuration Resolver 212 of FIG. 2) may be configured to obtain Template Config 306 (e.g., a template configuration file) and Input Config 308 (a corresponding input configuration file) to generate Merged Config 312 (e.g., a configuration file including a merger of the Template Config 306 and the Input Config 308).

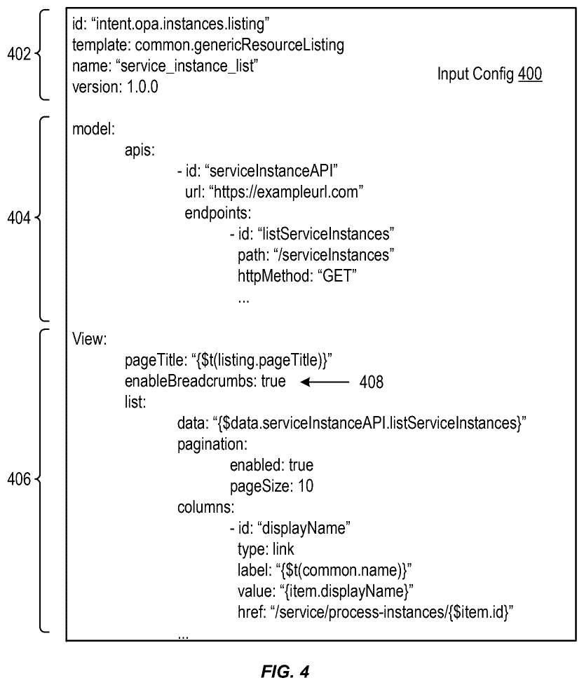

FIG. 4 depicts of an example Input Config 400, according at least one embodiment. Input Config 400 may be an example of the Input Config 308 of FIG. 3 (e.g., an input configuration file developed by the Plugin Team 304 of FIG. 3). Input Config 400 may be used to provide business logic that defines from where and how data that is to be presented at the page is to be obtained, the actions a user may take, application programming interfaces to be used to obtain the data to be presented, and the like.

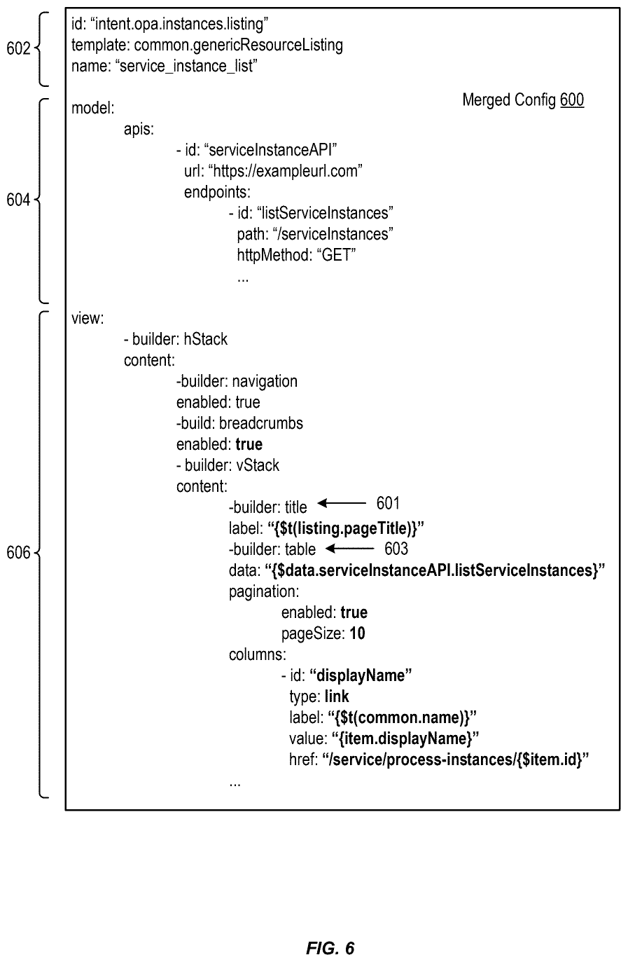

In some embodiments, Input Config 400 may include any suitable number of data values and/or sources (e.g., data value 408). These values and/or sources may be used to populate corresponding data placeholders of Template Config 500 of FIG. 5. By way of example, merging the Template Config 500 with Input Config 400 to generated Merged Config 600 of FIG. 6 may include populating placeholder 508 of FIG. 5 with data value 408.

Input Config 400 may include Input Config Metadata 402. Input Config Metadata 402 may include any suitable number and type of attributes and corresponding values with which the Input Config 400 may be uniquely identified. As depicted in FIG. 4, Input Config Metadata 402 may include any suitable number of data attributes and corresponding values. For example, Input Config Metadata 402 may include an identifier for the intent to which the input config is associated with a corresponding value of “intent.opa.instances.listing”, a template identifier that specifies which template configuration file is to be used with this input config to render the page corresponding to the intent with a corresponding value of “common.genericResourceListing”, a name for the Input Config 400 with a value corresponding to “service_instance_list”, and a version identifier with a corresponding value of “1.0.0”. The specific metadata included in Input Config Metadata 402 is provided for illustration purposes and is not intended to limit the scope of this disclosure. A different number of data attributes and corresponding values may be similarly used.

In some embodiments, rendering performed by a rendering plugin (e.g., the Rendering Plugin 222 of FIG. 2) may utilize a Model/View/ViewModel (MVVM) architectural pattern that defines rendering a UI through three main components: a Model, a View, and a ViewModel. Therefore, in some embodiments, Input Config 400 may include any suitable metadata corresponding to a MVVM architectural pattern. In a MVVM architectural pattern, a Model represents a data model abstraction and business logic that powers the page. It instructs the data access layer to read and write data to the backend services. The Model stores the raw data (e.g., data obtained from a backend server) and performs any necessary data manipulation on it, such as aggregation and transformation, to produce materialized data (e.g., the type of data the View needs to consume and render on the screen. The View of a MVVM architectural pattern represents the presentation layer and what the user sees on the screen. The View may include a collection of components and visual elements that display information and receive user input. The View contains no business logic (besides minimal UI specific logic to handle interactions and animations) or data (besides a local component state). The ViewModel of a MVVM architectural pattern represents an abstraction that links and sits between the Model and the View components. The ViewModel exposes properties that the View can directly bind to. This enables the ViewModel to instruct the View on what to render and keep the UI updated. It also enables the ViewModel to receive user input from the view. The ViewModel can bind to one or more models (as data sources) to assemble and refresh the data needed for rendering (re-materialization).

As depicted in FIG. 4, Input Config 400 may include Model Metadata 404 that may

correspond to a Model component of a MVVM architectural pattern. Model Metadata 404 may identify any suitable number of application programming interfaces (APIs), function calls, method calls, endpoints, URLs, identifiers, or any suitable data with which data to be presented at the page associated with the Input Config 400 is to be rendered. As depicted, Model Metadata 404 specifies an application programming interface (API) with an id of “service InstanceAPI”, a URL (e.g., http://exampleurl.com) and an endpoint. The endpoint may be associated with an identifier (e.g., “listServiceInstances”), a path (e.g., “/serviceInstances”), and a method to be called to obtain data (e.g., an httpMethod named “GET”). Although not depicted in FIG. 4, Input Config 400 may include actions and trigger definitions. An “action” refers to a logical encapsulation of operations such as data fetching, data manipulation, mutating a state of the web application 232, and the like. In some embodiments, actions may be implemented as React hooks (e.g., hooks defined in a React JavaScript library). A “trigger” refers to events that initiate one or more actions. A trigger may be based at least in part on a system event (e.g., a timer, an error, a notification, loading/unloading, or the like. In some embodiments, a trigger may be implemented as a Redux dispatch function (e.g., a dispatch function of an open-source Redux library for managing application state).

As depicted in FIG. 4, Input Config 400 may include View Metadata 406 that may correspond to a View component of a MVVM architectural pattern. View Metadata 406 may include any suitable data that may be used to determine how data obtained via the APIs listed in Model Metadata 404 is to be displayed within the page. As depicted in FIG. 4, View Metadata 406 may be utilized to identify that a list should be used to present data obtained using the API depicted in Model Metadata 404. View Metadata 406 may include any suitable attributes for specifying how the data is to be presented such as whether pagination is enabled, a page size (e.g., 10), attributes of one or more columns of the list, attributes of one or more rows of the list (not depicted), and the like. As depicted, View Metadata 406 may specify a page title and an indicator that breadcrumbs is enabled.

FIG. 5 depicts an example template configuration file (e.g., Template Config 500), according to at least one embodiment. Template Config 500 (an example of the Template Config 306 of FIG. 3) may be used to declaratively specify at least a portion of a page format and/or layout, a set of component intents (e.g., component intents 501 and 503) with which concrete components to be rendered at the page may be identified, and respective data bindings.

In some embodiments, Template Config 500 may include any suitable number of data placeholders (e.g., placeholder 508). These placeholders may be populated with data values and/or sources specified in Input Config 400 of FIG. 4. By way of example, merging the Template Config 500 with Input Config 400 to generated Merged Config 600 may include populating placeholder 508 with data value 408 of FIG. 4.

In some embodiments, Template Config Metadata 502 may include any suitable number and type of attributes and corresponding values with which the Template Config 500 may be uniquely identified. As depicted, Template Config Metadata 502 includes a name attribute with a corresponding value of renderingPlatform.resourceListing, a “type” attribute with a corresponding value of “common.genericResourceListing”, and a version identifier with a corresponding value of “2.3.4”. In some embodiments, Template Config 500 may be identified based at least in part on an attribute provided in an input configuration file (e.g., via the template attribute of Input Config 400 of FIG. 4 with a corresponding value of “common.genericResourceListing”). In some embodiments, an input configuration file and a template configuration file may be associated with one another based at least in part on a template attribute value of the input configuration file that matches a “type” attribute value of the template configuration file.

Like the Input Config 400 discussed above in connection with FIG. 4, the Template Config 500 may include any suitable metadata corresponding to a Model/View. ViewModel (MVVM) architectural pattern. By way of example, Model Metadata 504 may correspond to the Model component of an MVVM architectural pattern utilized by the Rendering plugin 222 of FIG. 2. Model Metadata 504 may specify placeholder for any suitable number of APIs, actions, and/or triggers required for the user interface. Placeholders may be used to indicate where the actual data will be injected at runtime.

The View Metadata 506 may correspond to the View component of an MVVM architectural pattern. View Metadata 506 may include any suitable data that defines an abstraction of a layout, format, structure, or abstract components of the page to be rendered. It may use a hierarchical structure to define the layout and content. As depicted in FIG. 5, Template Config 500 may specify that the page includes a title and a table (e.g., an abstract component) with placeholders for table metadata such as the API used to obtain the data to be presented in the table, pagination parameters associated with the table, column metadata associated with the columns of the table, and the like.

Returning, briefly, to FIG. 3, the Configuration Resolver 310 may be a runtime component that may be configured to generate Merged Config 312. Merged Config 312 may be generated based at least in part on combining/merging the Template Config 306 and the Input Config 308.

FIG. 6 illustrates a depiction of an example Merged Config 600 (also referred to as a “user interface configuration file”), according to at least one embodiment. In some embodiments, the Merged Config 600 is an example of the Merged Config 312 of FIG. 312 (e.g., a merged configuration file generated by the Configuration Resolver 310 of FIG. 3).

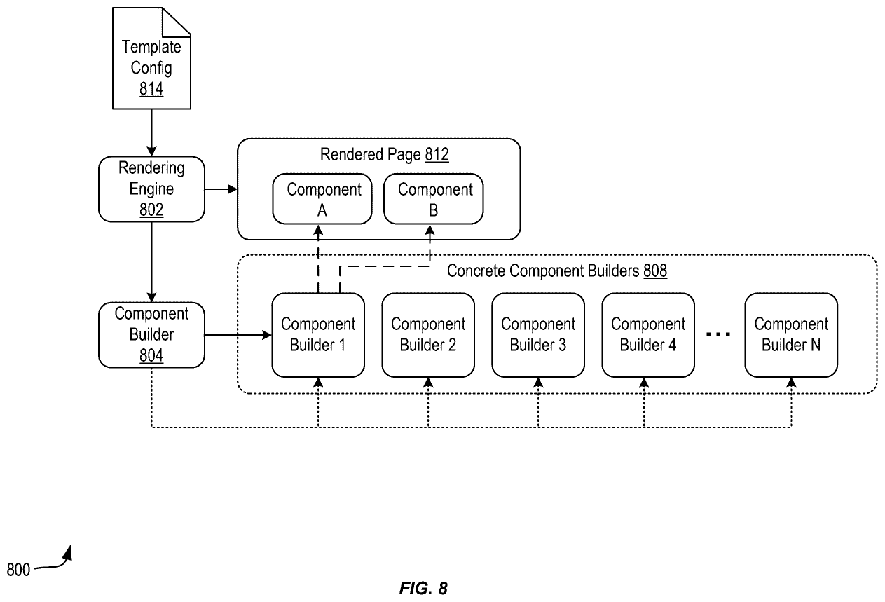

The Merged Config Metadata 602, Meged Model Metadata 604, and Merged View Metadata 606 may be dynamically generated (e.g., by the Configuration Resolver 310) by the merging a corresponding template configuration file and input configuration file. Merged Config 600 is intended to depict a merger of Input Config 400 of FIG. 4 and Template Config 500 of FIG. 5. Merging the template configuration file and the input configuration file may include replacing placeholders of the template configuration file with data values and/or sources of the input configuration file. In some embodiments, Merged Config 600 may include one or more component intents (e.g., component intent 601) with which a concrete component may be generated (e.g., using one of the Concrete Component Builders 808 of FIG. 8).

By way of example, Model Metadata 604 may be generated based at least in part on injecting the data values identified in Model Metadata 404 of Input Config 400 to replace injectable variables (e.g., placeholder 508) identified in Model Metadata 506 of Template Config 500. By way of example, the variable {$model.apis} of Model Metadata 604 may be replaced with the API(s) defined in Model Metadata 404. If actions and/or triggers values are defined in the corresponding input configuration file, these too may be used to replace corresponding placeholders (e.g., variable {$model.actions} and {$model.triggers}) of Model Metadata 604, respectively.

Similarly, View Metadata 606 may be generated based at least in part on injecting/replacing variables of View Metadata 506 of Template Config 500 with the corresponding data values provided in View Metadata 406 of Input Config 400. Merged Config 600 may represent a specification of the page that can be rendered because the aspects of the Input Config 400 and the Template Config 500 are present, enabling the formatting/layout and components to be identified as well as the business logic for retrieving and presenting the data at the rendered page.

Returning to FIG. 3, the Configuration Resolver 310 may take an intent as an input, fetch the corresponding Input Config 308 and Template Config 306 from the Config Registry 224 of FIG. 2, perform runtime validation of the Input Config 308 and Template Config 306, and merge the two to produce a Merged Config 312. In some embodiments, performing runtime validation may include validating that the Input Config 308 and the Template Config 306 are both well-formed and that data provided in Template Config 306 (e.g., placeholder variables) has corresponding data within Input Config 306. By way of example, runtime validation may fail if a placeholder variable included in Template Config 306 and the Input Config 308 has not data specified that corresponds to that placeholder value. If runtime validation passes, the Merged Config 312 may be passed from the Configuration Resolver 310 to the Rendering Engine 314, an example of the Rendering Engine 222 of FIG. 2).

The Rendering Engine 314 (e.g., the Rendering Engine 218 of FIG. 2) may be a runtime component responsible for rendering the user interface based on the merged configuration provided by the Configuration Resolver 310 (e.g., Configuration Resolver 212 of FIG. 2). The Rendering Engine 314 may perform several functions, including processing merged configuration files (e.g., the Merged Config 312), instantiating the necessary visual and headless components as defined by a merged configuration file, binding these components together, and rendering the final user interface on the screen as Page 316 (e.g., Page 110 of FIG. 1).

Returning to FIG. 2, the Rendering Engine 218 may be configured to obtain page-level data from Page-Level Data Store 226. Page-Level Data Store 226 may include a page-specific model that stores page-level context and state such as filter/sort choices, form data, implementation counters/toggles, etc. In some embodiments, Page-Level Data Store 206 may be managed based at least in part on a library (e.g., an open-source JavaScript Library such as Redux, a library configured to manage and centralize application state).

Rendering Engine 218 may be configured to access App/User Data Store 228. App/User Data Store 228 may store a shared model (e.g., a Model/View/ViewModel (MVVM) architectural pattern model) that stores application content and state such as feature toggles and user selections (e.g., locale, theme, time zone, active region, active compartment, etc.). App/User Data Store 228 may be managed based at least in part on a library (e.g., Redux) installed as part of web application 232. The App/User Data Store 228 may store application-specific and user-specific data, such as user preferences, session data, and contextual information, which may be used to personalize and optimize the user experience.

In some embodiments, the Rendering Engine 218 may be configured to invoke the functionality of Component Builder 214. The Component Builder 214 may be configured to instantiate the necessary visual components for the user interface as specified by the merged configuration. It may serve as an abstraction layer that allows for the use of different underlying component libraries without tying the Rendering Engine 218 to a specific concrete component library (e.g., OUI, React, Jet, etc.). The Component Builder 214 may be configured to utilize a common interface to access any suitable number of concrete component builders (e.g., corresponding to concrete component libraries). The Concrete Component Builder 216 may correspond to a specific concrete component library of many concrete component libraries that are available and that provide specific implementations of the components that may be rendered at the page. Each of these libraries may implement a different look and feel of the same components (e.g., a table, a set of radio buttons, edit boxes, etc.). In some embodiments, the App/User data may indicate which concrete component builder to use to generate components for the page. In some embodiments, Rendering Engine 218 may provide any suitable portion of data obtained from App/User Data Store 228 to Component Builder 214, which in turn may use the App/User Data to select Concrete Component Builder 216 (e.g., a concrete component builder that utilizes a specific concrete component library) for building the components to be rendered at the page. Alternatively, Rendering Engine 218 may identify which concrete component library to use from App/User data and may indicate the concrete component library to use when it sends a request to create the component to the Component Builder 214. In some embodiments, Component Builder 214 may select the Concrete Component Builder 216 based at least in part on the provided App/User data.

In some embodiments, Rendering Engine 218 may be configured to invoke the functionality provided by Data Gateway 220. Data Gateway 220 may be configured to facilitate communication between the Rendering Engine 218 and Backend APIs 210 (e.g., APIs specified by the Input Config 400 of FIG. 4). The Data Gateway 220 may be configured to manage any suitable combination of data retrieval, aggregation, transformation, and/or caching, ensuring that the Rendering Engine 218 has the necessary data to display.

The Web Application 232 may be any suitable web application at which the Rendering Plugin 222 may be installed. As a non-limiting example, Web Application 232 may be an example of the Oracle Cloud Infrastructure (OCI) Console.

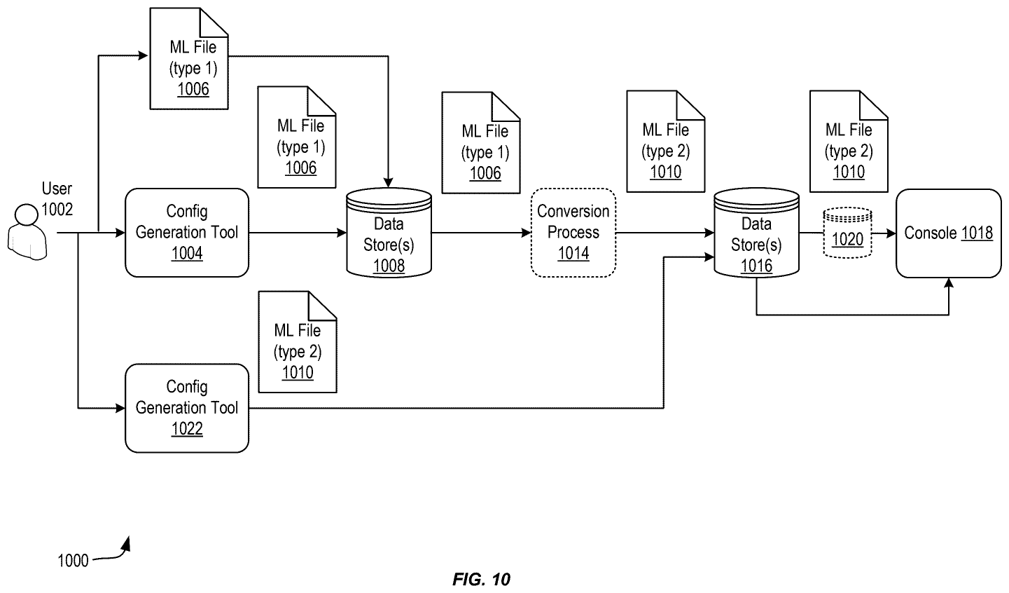

In some embodiments, pages rendered by the Rendering Engine 218 may be configured to emit metrics, logs, and analytics. This functionality may cover common use cases such as availability, performance, page load times, processing and rendering times, task execution times, system failures, and user errors. These metrics may be tied with out-of-the-box alarms and Grafana dashboards with pre-defined Service Level Agreements (SLAs), enabling plugin teams to monitor their page's provided user experience in production. This may provide the platform team with a holistic view of the entire product, including its performance and potential issues or degradation. The metrics and alarms emitted by the pages rendered by Rendering Engine 218 may help determine whether incidents should be directed to an OCI Console team (e.g., a development team associated with Web Application 232), the MAUI team (e.g., a development team associated with the Rendering Engine 218), or the plugin teams (e.g., a development team associated with the page being rendered), ensuring that the appropriate on-call personnel may be notified. Additionally, plugin teams to may be provided tools (e.g., Config Generation Tool 1004 of FIG. 10) to define additional custom telemetry, providing flexibility to monitor specific aspects of their plugins as needed.

Using the components presented in FIG. 2, a number of use cases are enabled. One use case may involve changing the desired layout of a Rendered Page. In some embodiments, a redesigned layout and/or styling may be specified in a new template configuration file, for which the previously used template configuration file may be swapped out. In some embodiments, “swapping out” one template configuration file for another may include overwriting the previous template configuration file with the new template configuration file. The new template configuration file may be combined with the existing input configuration file by the Configuration Resolver 310 without any changes required by a corresponding plugin team (e.g., the team responsible for defining the input configuration file). By using the same input configuration file, the same business logic and data processing may be reused with new formatting/layout/styling of the new template configuration file, enabling the format/layout/style of the page to be changed on the fly, at runtime. In some embodiments, updating or overwriting a template configuration file may effectuate to update to format/layout/style of a given page without requiring the web application 232 to be restarted.

As another use case, template configuration files may be used to swap between device form factors. One template configuration file may provide a mobile-specific template that defines a layout/format/style to be used for mobile devices. Another template configuration file may be used to provide a different layout/format/style for other, non-mobile devices. Each of these templates may be usable with the same input configuration file (e.g., Input Config 308 of FIG. 3). A non-mobile template may be used to define a layout and component structure that is optimized for non-mobile devices. This non-mobile template may be utilized (e.g., by the Configuration Resolver 210) with the input configuration file when the device requesting the page is a non-mobile device. The mobile-specific template configuration may define a layout and component structure optimized for mobile devices. The Configuration Resolver 210 may merge this mobile template configuration file with the same input configuration file used for the non-mobile device, allowing the application to render many device specific or form factor specific interfaces while reusing the same underlying data processing logic provided in the input configuration file.

One advantage of this disclosed techniques may be the ability to swap templates while keeping the input configuration file intact, which may enable seamless updates and enhancements. A common template configuration file may be utilized by many pages, with differing input configuration files defining the page-specific business logic. In some embodiments, the common template configuration file may be updated once to apply a change to every page for which the common template configuration file is utilized in the process of rendering the page. The utilization of template configuration files as described herein may provide support for incremental feature rollouts, such as adding time zone support, without requiring changes to the underlying input configuration files.

In some embodiments, the merging operation described as being performed by the Configuration Resolver 310 may alternatively be performed by a server-side job. This server-side job may trigger the merging operation whenever the template or input configuration files are updated, such as during a deployment trigger. In some embodiments, the merging process could be provided as part of a server-side rendering process, which may further streamline the rendering process and improve performance by offloading the computational load from the client-side to the server-side.

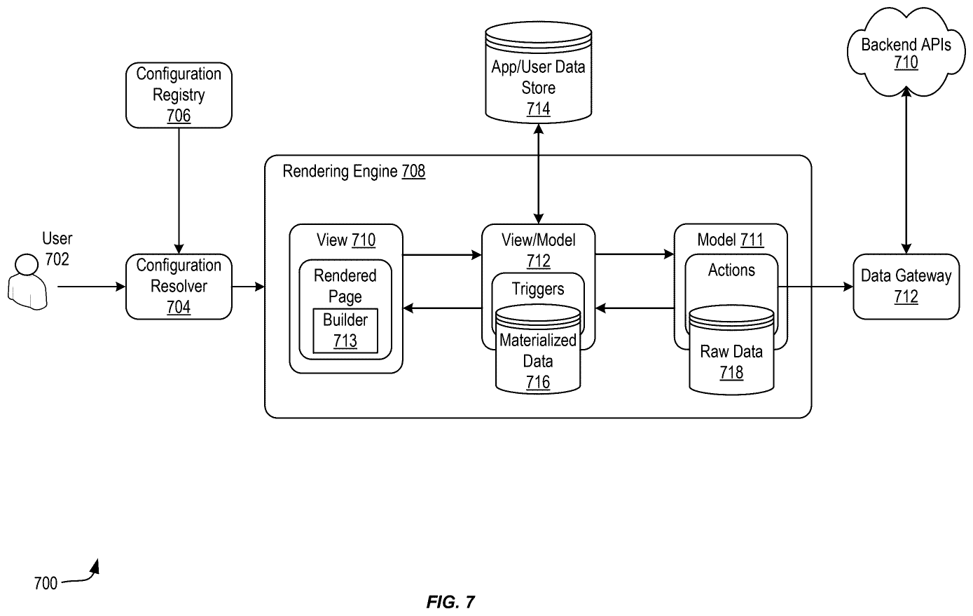

FIG. 7 is a block diagram illustrating components of a web application environment 700 including an example Rendering Engine 702, according to at least one embodiment. The Rendering Engine 702 may be an example of the Rendering Engine 218 of FIG. 2 and/or Rendering Engine 314 of FIG. 3. In some embodiments, the web application environment 700 may include various components that interact to dynamically render user interfaces based on configuration files (e.g., the configuration files described above in connection with FIGS. 4-6) and data.

In some embodiments, the web application environment 700 may begin with a User 702 who initiates a request to render a page. This request may be processed by the Configuration Resolver 704 (e.g., the Configuration Resolver 212 of FIG. 2), which may fetch configuration files corresponding to the requested page path from the Configuration Registry 706 (e.g., the Configuration Registry 224 of FIG. 2). The Configuration Resolver 704 may be configured to merge the obtained configuration files (e.g., Template Config 306 of FIG. 3 and Input Config 308 of FIG. 3) to create a merged configuration file (e.g., Merged Config 312 of FIG. 3) for rendering.

The merged configuration file may then be passed to the Rendering Engine 708. The Rendering Engine 708 may be responsible for interpreting the merged configuration file and orchestrating the rendering process. It may instantiate necessary visual components and bind data to these components to create the final rendered page.

The Rendering Engine 708 may be configured to implement a Model/View/ViewModel (MVVM) architectural pattern using Model 711, View 710, and View/Model 712. Model 711 may represent a data model abstraction and business logic that powers the page. Model 711 the data access layer to read and write data to the backend services. The Model 711 may include actions that define various operations, such as data retrieval and manipulation (e.g., aggregation and/or transformation, etc.), which are performed using the Raw Data 718 store to produce materialized data with which the View 710 needs to consume to render the page. The Model 711 may be configured to provide this materialized data to View/Model 712 which in turn may store the data in Materialized Data 716 (e.g., a data store configured to store such information). The Model 711 may be configured to interact with Data Gateway 712 (an example of Data Gateway 220 of FIG. 2) to fetch and process data obtained via Backend APIs 710 (e.g., Backend APIs 210 of FIG. 2). The Backend APIs 710 may be utilized to obtain external data for displaying the data at the rendered page according to the merged configuration file.

The View 710 of Rendering Engine 708 may be configured to handle visual representation of the user interface. The View 710 may utilize builder 713 (e.g., a concrete component build by a concrete component library) to instantiate and configure UI components dynamically based on the merged configuration file. These UI components may be used to display information and/or to receive user input. The View 710 may contain no business logic (besides minimal UI specific logic to handle interactions and animations) or data (besides a local component state). The rendered page may be the final visual output presented to the user.

The View/Model 712 of the Rendering Engine 808 may be configured to manage the data and state associated with the user interface. The ViewModel 712 may be an abstraction that links and sits between the Model 711 and View 710 components of the Rendering Engine 708. The ViewModel 712 may be configured to expose properties that the View 710 can directly bind to. This enables the ViewModel 712 to instruct the View 710 on what to render and how keep the UI updated. It also enables the ViewModel 712 to receive user input from the View 710. The

ViewModel 712 may bind to one or more models (as data sources) to assemble and refresh the data needed for rendering (re-materialization). The View/Model 712 may include triggers that respond to user interactions and other events, updating the Materialized Data 716 store as necessary. The View/Model 712 may be configured to ensure that the user interface remains responsive and interactive.

Data required for rendering the user interface may be managed, at least in part, by the App/User Data Store 714. The App/User Data Store 714 may contain broader application-specific and user-specific data, such as user preferences and session information.

The process depicted in FIG. 7 may begin with a User 702 initiating a request that is processed by the Configuration Resolver 704. Configuration Resolver 704 may fetch and merge the configuration files obtained from Configuration Registry 706, passing the merged configuration to the Rendering Engine 708. The Rendering Engine 708 may then interpret the merged configuration, interact with the Data Gateway 712 to fetch data in accordance with the merged configuration file, and render the final page using components instantiated by the Builder 713, which may be selected from many available Builders based at least in part on data obtained from the App/User Data Store 714.

FIG. 8 is a block diagram 800 depicting example interactions between a Rendering Engine 802 and a Component Builder 804, according to at least one embodiment. In some embodiments, the Rendering Engine 802 and Component Builder 804 interact to facilitate the dynamic construction and rendering of user interface components (e.g., concrete components).

The Component Builder 804 may be responsible for instantiating the appropriate UI components based on the configuration provided by the Template Config 814 (and/or a corresponding merged configuration file such as Merged Config 600 of FIG. 6). The Component Builder 804 may serve as an abstraction layer that may be configured to select a builder from Concrete Component Builders 808 with which the UI components may be generated. In some embodiments, the Component Builder 804 may use a common interface to interact with any suitable number of Concrete Component Builders 808. Component Bulder 804 and Concrete Component Builders 808 may implement a builder design pattern in which creation and assembling of parts of a complex object (e.g., an object corresponding to Component A) is encapsulated in a separate builder object. Concrete Component Builders 808 may be different user interface component libraries and/or frameworks specifying different implementations for generating any suitable number of concrete components. Some example concrete component builders/libraries may include React, OUI, JET, Preact, Fluent, or the like. As a non-limiting example, Concrete Builder 1 may be a JavaScript library and Concrete Builder 2 may be a different JavaScript library. In some embodiments, the Component Builder 804 may be configured to delegate object creation to one of the Concrete Component Builders 808, which in turn may be responsible for creating instances of specific components required by the Rendering Engine 810. The use of Component Builder 804 may ensure that the Rendering Engine 810 is not tied to any specific component library (e.g., the library corresponding to component Builder 1) or design language, providing flexibility and modularity.

As a non-limiting example, Rendering Engine 802 may invoke the functionality of Component Builder 804 to generate any suitable abstract component (e.g., builder: table, corresponding to a component intent 503 and/or 603 of FIGS. 5 and 6, respectively) specified by the template configuration file (or the template configuration file portion of the merged configuration file), passing App/User data via the invocation (e.g., via function call). Based at least in part on the App/User data (e.g., data obtained from App/User Data Store 228 of FIG. 2 such as user data, device data, browser data, etc.), the input configuration file, and/or the web application, the Component Builder 804 may be configured to select Component Builder 1 from Concrete Component Builders 808 according to a predefined rule set implemented by the Component Builder 804 and/or based on a concrete component library indicated in the App/User data. The Component Builder 804 may map an abstract component (e.g., builder: table, corresponding to a component intent “table”) to a concrete component of the Concrete Component Builder it selected from the Concrete Component Builders 808 (e.g., Component Builder 1). Component Builder 1 (e.g., a OUI library, an Oracle Jet library, a React library, etc.) may be used to instantiate component A and component B. In this manner, Rendering Engine 802 may utilize any suitable combination of the Concrete Component Builders 808 to instantiate any suitable component of a page (e.g., page 812, and example of page 110 of FIG. 1). Page 812 may be the final output displayed to the user, which may comprise various UI components (e.g., component A and component B as defined by the template config 814 (or a corresponding merged config).

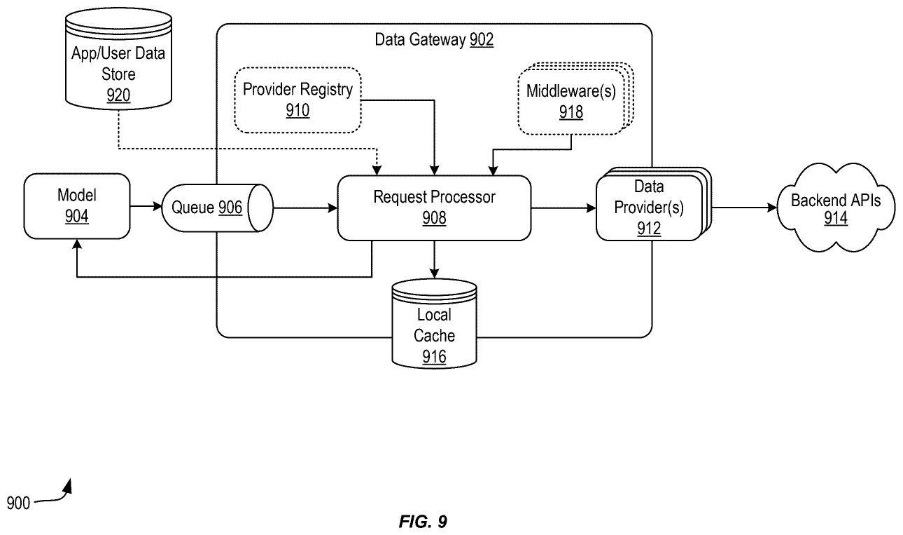

FIG. 9 illustrates a block diagram of example components of a Data Gateway 902 within a web application environment 900, according to at least one embodiment. The Data Gateway 902 may also be referred to as a “console gateway.” In some embodiments, the web application environment 900 may include various components that interact to facilitate efficient data management and retrieval. In some embodiments, Data Gateway 902 may serve as a common entry point for any suitable number of data sources (e.g., data sources corresponding to backend APIs 914). Data Gateway 902 may be configured to utilize a user interface configuration file (e.g., Merged Config 600 of FIG. 6) to perform any suitable function. In some embodiments, Data Gateway 902 may perform common functions for any suitable number of UI configuration files including, but not limited to, authentication, authorization, logging, metrics generation, caching, data aggregation, data transformation, rate limiting, reties, error handlings, or the like. The Data Gateway 902 may be configured to perform these common functions in a uniform fashion across any suitable number of data sources. In some embodiments, the UI configuration file may include any suitable combination of an application programming interface with which the Data Gateway 902 is to retrieved data, a transformation rule with which the Data Gateway 902 is to perform transformation, or an aggregation rule with which the Data Gateway 902 is to aggregate data.

In some embodiments, the web application environment 900 may include Model 904. Model 904 may be an example of Model 711 of FIG. 7, a component of a Rendering Engine (e.g., Rendering Engine 708 of FIG. 7). The Model 904 may initiate data requests (e.g., based on actions defined in a merged configuration file corresponding to the page) that are managed by the Queue 906, which may be configured to organize these requests in an orderly manner (e.g., first in, first out) to handle concurrency and prioritization effectively.

The Request Processor 908 of the Data Gateway 1020 may be configured to dequeue requests from the Queue 906 and consult the Provider Registry 910 to identify the appropriate Data Providers 912 with which Backend APIs 910 are utilized. The Provider Registry 910 may be configured to maintain a comprehensive list of available Data Providers 912 and their capabilities, allowing the Request Processor 908 to determine which Data Provider 912 to use for a specific request.

The Data Providers 912 may be configured to execute specific data retrieval operations. In some embodiments, Data Providers 912 may be configured to call Backend APIs 914 or access other data sources to fetch the data needed for rendering the page. Data Providers 912 may be configured to perform tasks such as fetching data, transforming and aggregating data, managing pagination, and handling retries. This interaction may ensure that the necessary data is obtained efficiently and accurately.

The Backend APIs 914 may be external APIs and services from which Data Providers 912 may fetch data. These APIs may be configured to provide at least some of the data needed for the application to function correctly. The fetched data may be further processed by the Data Providers 912 and/or Request Processor 908 before being provided to Model 904 in response to the request.

To minimize latency and reduce the load on Backend APIs 914, the Data Gateway 902 may include a Local Cache 916 (e.g., a centralized cache). The Local Cache 916 may frequently store accessed data (e.g., data obtained via Backend APIs 914) and supports various caching strategies, such as Least Recently Used (LRU), to optimize data retrieval. By storing data locally, the Local Cache 916 may reduce the need for repeated data fetches from remote sources (e.g., via Backend APIs 914).In some embodiments, Data Gateway 902 may utilize cross-page caching. In cross-page caching, one page may fetch data (e.g., from Local Cache 916) that has already been retrieved by another page, such as a list of compartments, capabilities, VCNs, and subnets. This may reduce redundancy and improve performance by leveraging previously fetched data which may be obtained from Local Cache 916 instead of utilizing Backend APIs 914 once more. Further embodiments which utilize Local Cache 916 may enable cross-session caching, where data fetched during one session is retained across page refreshes or new sessions, such as polling for updates on long-running operations. The configuration utilized for Local Cache 916 may define caching parameters, including eviction policies like LRU (Least Recently Used) for remembering the last-accessed resources and refresh intervals that can vary based on the data's importance and update frequency.

In some embodiments, Data Gateway 902 may centralize and share caching between different UIs. For example, the Data Gateway 902 may be configured to handle all UIs. In these examples, there may be little or no need for each plugin to maintain a separate cache as these plugins (e.g., Plugin 106 of FIG. 1, Plugin 208 of FIG. 2, etc.). This centralized approach may enhance efficiency and reduce redundancy, ensuring that data is consistently and readily available across various user interfaces within the application environment. This capability may improve performance and user experience by minimizing data retrieval times and leveraging shared resources effectively.

The Data Gateway 902 may be enhanced by Middleware Components 918, which may be configured as modular, pluggable units that may modify and/or augment the data processing pipeline of Data Gateway 902. Middleware Components 918 may be utilized by the Request Processor 908 and may be configured to handle tasks such as logging, error handling, request signing, and data transformation, providing flexibility and customization in the data retrieval process.

The App/User Data Store 920 may hold application-specific or user-specific data, such as filters, sort options, and other contextual information that influence data operations and caching strategies. Data obtained from App/User Data Store 920 may be used by Request Processor 908 to ensure that the application has access to relevant and up-to-date information to personalize and optimize the user experience.

In some embodiments, Data Providers 912 may be provided as common, out-of-the-box data providers, or the Data Providers 912 may be implemented as custom providers. Data Providers 912 may be configured with authentication mechanisms such as web request signing or mTLS, and may perform data transformation, aggregation, pagination, caching (persisted to memory, disk, or backend), and retries (including jitter, rate limiting, throttling, and circuit breaking), or the like. In their simplest form, data providers may fetch static assets or make simple REST API calls, ensuring flexibility and extensibility in data management.

FIG. 10 illustrates a block diagram of an example process 1000 for authoring, hosting, and delivering configuration files, according to at least one embodiment. In some embodiments, the process 1000 may utilize various tools and components that interact to create, store, and deploy configuration files dynamically.

In some embodiments, User 1002 upload markup language (ML) file 1006 directly to data store(s) 1008 or user 1002 may interact with a Config Generation Tool 704 to generate ML file 1006 which is then stored in data store(s) 1008. ML file 1006 may be an example of a template configuration file (e.g., Template Config 306 of FIG. 3) or an input configuration file (e.g., Input Config 308 of FIG. 3). In some embodiments, the ML file 1006 may be a first type (e.g., “type 1”) that may correspond to a first type of markup language. By way of example, ML file 1006 may be provided in Yet Another Markup Language (YAML), a human-readable data serialization language that may be used to write configuration files. In some embodiments, the Config Generation Tool 704 may include a graphical user interface or a command line interface.

The data store(s) 1008 may serve as a repository for uploaded and/or tool-generated configuration files, ensuring they are readily accessible for further processing.

At any suitable time, the ML files stored in data store(s) 1008 (e.g., ML file 1006 may be processed by a Conversion Process 1014, during which they may be transformed into another type of configuration file of a second type (e.g., “type 2”). As a non-limiting example, the second type of markup language may be JavaScript Object Notation (JSON), a text-based format for representing structured data that is both human and machine-readable. The conversion process 1014 may adapt the initial configuration files into a format suitable for deployment and execution within a web application environment (e.g., the web application environment 200 of FIG. 2). The converted ML files (e.g., ML file 1010) may be stored in Data Store(s) 1016.

Some embodiments may involve deploying the ML Files (type 2) of data store(s) 1016 to the Console 1018. The Console 1018 e.g., Console 104 of FIG. 1) may be the runtime environment where a web application executes (e.g., web application 232 of FIG. 2), rendering user interfaces and processing data based on the configurations provided. In some embodiments, Content Delivery Network (CDN) 1020 may be used to distribute the ML files from data store(s) 1016 to Console 1018. CDN 1020 may be an example of a distributed group of servers that are configured to cache content near end users/systems. Utilizing the CDN 1020 may reduce load times for loading the ML files into Console 1018.

A process depicted in FIG. 10, may begin with the User 1002 creating type 1 configuration files in a first language (e.g., YAML) manually, or by using the Config Generation Tool 704. These files may be stored in Data Store(s) 1016 and may undergo a Conversion Process 1014 process to produce type 2 configuration files in a second language (e.g., JSON). The converted files may be deployed to the Console 1018 directly, or via CDN 1020, where they may be used to configure the application dynamically. This architecture may ensure a streamlined and efficient process for authoring, hosting, and delivering configuration files within the web application environment, which may enhance scalability and maintainability.

In some embodiments, the ML files of FIG. 10 (e.g., each an example of a template or input configuration file) may be generated with a What You See Is What You Get (WYSIWYG) generator or a generator that implements artificial intelligence, which may further simplify the configuration creation process and improve usability. A WYSIWYG generator refers to a software program that allows content (e.g., an ML file) to be edited in a form that resembles its appearance when printed or displayed as a finished product. Config Generation Tool 1022 may be an example WYSIWYG generator or AI-assisted generator. In some embodiments, the Config Generation Tool 1022 may be used to produce ML file 1010 directly, allowing the ML file 1010 to be stored in Data Store(s) 1016 without the need of being generated through Conversion Process 1014.

In some embodiments, once the configuration files are generated, they may be validated prior to being stored within Data Store(s) 1016. In some embodiments, the MAUI Team may validate and store these config files in a central repository (e.g., Data Store(s) 1016) for subsequent use. The central repository may manage and deploy the configurations regularly and/or as needed. Plugin teams that prefer more control over their deployment cadence may host their config file(s) as static assets within their plugins. These teams can push their configurations to production as part of their regular plugin deployment process, offering flexibility and autonomy in managing their configuration deployments.

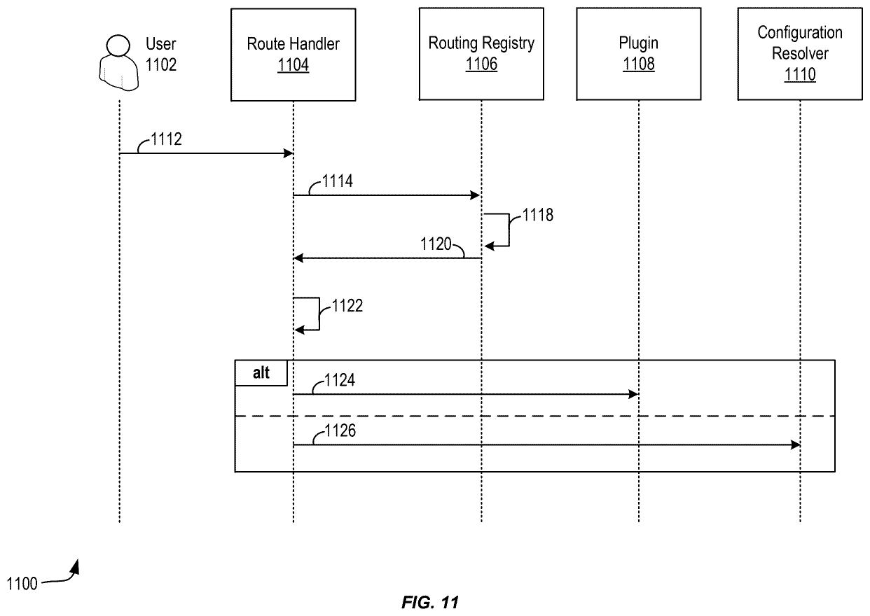

FIG. 11 is a block diagram illustrating an example method 1100 for routing a request to a plugin, according to at least one embodiment. In some embodiments, the web application environment 1100 may include various components that interact to manage and resolve user requests for rendering pages. The method 1100 may be performed with Route Handler 1104 (e.g., Route Handler 204 of FIG. 2), Routing Registry 1106 (e.g., Routing Registry 206 of FIG. 2), Plugin 1108 (e.g., Plugin 208 of FIG. 2), and Configuration Resolver 1110 (e.g., Configuration Resolver 212 of FIG. 2, a component of Rendering Plugin 222 of FIG. 2).

The method 1100 may begin at 1112, where User 1102 may initiate a request that identifies a Uniform Resource Locator (URL) corresponding to a user interface. The request may be received and processed by the Route Handler 1104.

At 1114, the Route Handler 1104 may extract the URL path from the URL and transmit the URL path to the Routing Registry 1106. As described above in connection with FIG. 2, Routing Registry 1106 may be configured with a mapping or other suitable object that maintains an association between a URL path and an intent that can be provided to a configuration resolver (e.g., Configuration Resolver 1110) at runtime that fetches input and template configuration files that correspond to the intent. In some embodiments, the Routing Registry 1106 maintains an association between the URL path, the corresponding intent, and a toggle. The toggle may be used to enable the path to be processed by the Rendering Plugin 222 of FIG. 2, instead of Plugin 1108 (e.g., Plugin 208 of FIG. 2, a plugin that handles rending of the requested page separate from the Rendering Plugin 222).

At 1116, the Routing Registry 1106 may be configured to retrieve the intent and/or the toggle value associated with the URL path received at 1114. At 1120, the Routing Registry 1106 may provide the intent and/or the toggle value to Route Handler 1104.

At 1122, Route Handler 1104 may determine, from the intent and/or toggle value received at 1120, whether to forward the intent to Configuration Resolver 1110 (a component a Rendering Plugin 222 of FIG. 2) or to Plugin 1108 (an example of Plugin 208 of FIG. 2). If the toggle value indicates (e.g., via a value of “0”) that the Plugin 1108 is to be utilized to process the request, the Route Handler 1104 may forward the request and/or intent to Plugin 1108 for rendering at 1124. Alternatively, if the toggle value indicates (e.g., via a value of “1”) that Rendering Plugin 222 is to be utilized for the request, the Route Handler 1104 may forward the intent to Configuration Resolver 1110 at 1126.

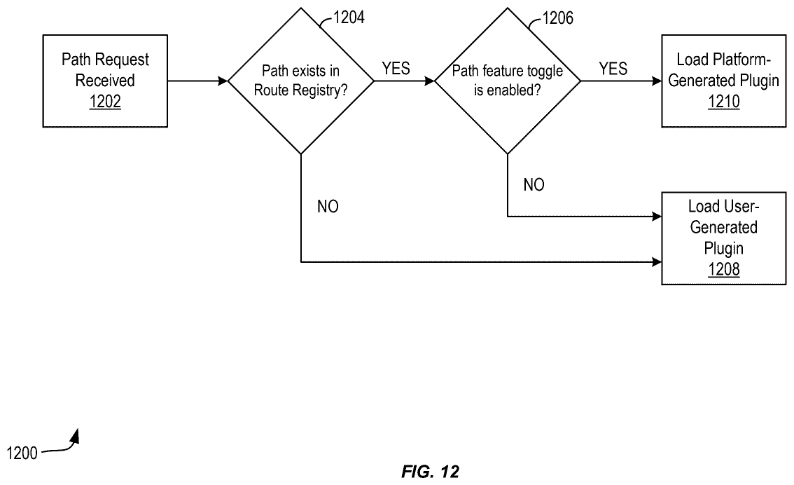

FIG. 12 is a block diagram depicting an example method 1200 for selecting a plugin to process a given request, according to at least one embodiment. In some embodiments, the method 1200 may be performed by a Routing Registry (e.g., Routing Registry 1106 of FIG. 11). In some embodiments, method 1200 may include more or fewer steps than the number depicted in FIG. 12. It should be appreciated that the steps of method 1200 may be performed in any suitable order.

The method 1200 may begin at 1202, where a path request is received (e.g., from the Route Handler 1104 of FIG. 11). The path request may include a URL path.

At decision block 1204, the Routing Registry may check whether the path exists in the Route Registry (e.g., a mapping or object that maintains associations between a URL path, an intent, and a toggle value). If the path exists in the Route Registry, the method 1200 may proceed to the next decision block at 1206. If the path does not exist in the Route Registry, the method 1200 may proceed to 1208 where the determination is made to load a user-generated plugin (e.g., Plugin 208 of FIG. 2).

If the method 1200 proceeds from decision block 1204 to decision block 1206, a determination may be made at decision block 1206 as to whether the toggle is enabled. The toggle may be considered enabled when a toggle value associated with the path is set to “1” or “true.” Conversely, the toggle may be considered not enabled when the feature toggle value associated with the path is set to “0” or “false.” If a determination is made that the toggle is not enabled for the path, method 1200 may proceed 1208, where a determination is made to load the user-generated plugin. If a determination is made at decision block 1206 that the toggle is enabled for the path, the method 1200 may proceed to 1210, where a determination is made to load a platform-generated plugin (e.g., Rendering Plugin 222 of FIG. 2).

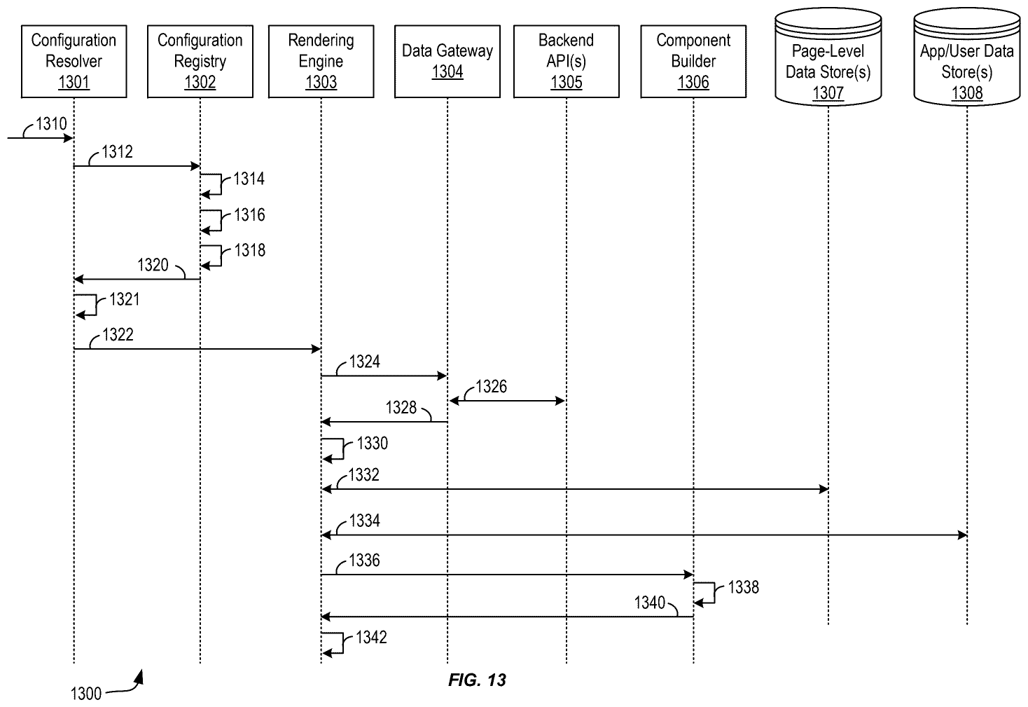

FIG. 13 is a sequence diagram depicting an example method 1300 for processing a request by various components associated with a Rendering Plugin (e.g., the Rendering Plugin 222 of FIG. 2), according to at least one embodiment. Method 1300 may be performed using Configuration Resolver 1301 (e.g., Configuration Resolver 212 of FIG. 2), Configuration Registry 1302 (e.g., Configuration Registry 224 of FIG. 2), Rendering Engine 1303 (e.g., Rendering Engine 218 of FIG. 2), Data Gateway 1304 (e.g., Data Gateway 220 of FIG. 2), Backend APIs 1305 (e.g., Backend APIs 210 of FIG. 2), Component Builder 1306 (e.g., Component Builder 214 of FIG. 2), Page-Level Data Store(s) 1307 (e.g., Page-Level Data Store(s) 226 of FIG. 2), and App/User Data Store(s) 1308 (e.g., App/User Data Store 228 of FIG. 2). In some embodiments, method 1300 may include more or fewer steps than the number depicted in FIG. 13. It should be appreciated that the steps of method 1300 may be performed in any suitable order.

The method 1300 may begin at 1310, where the Configuration Resolver 1301 may receive a request including an intent. The request may be considered a request to render the page. The intent may correspond to a page for which rendering is being requested. As described in the above figures, Configuration Resolver 1301 may be responsible for initiating the process at by fetching the input and/or template configuration files corresponding to the requested page.

At 1312, the Configuration Resolver 1301 may transmit the intent to the Configuration Registry 1302. The Configuration Registry 1302 may act as a central repository, storing any suitable input and template configuration files for various rendering user interfaces.

At 1314, the Configuration Registry 1302 may use the intent to lookup a corresponding input configuration file (e.g., Input Config 400 of FIG. 4). Looking up the input configuration file may include identifying, from various available input configuration files, a particular input configuration file that includes an identifier (e.g., via Input Config Metadata 402) that matches the intent.

At 1316, Configuration Registry 1302 may identify a template configuration specified in the retrieved input configuration file. By way of example, the Configuration Resolver 1301 may retrieve a value corresponding to a template attribute of the Input Config Metadata 402.

At 1318, the Configuration Registry 1302 may look up a template configuration file (e.g., Template Config 500 of FIG. 5) that includes an attribute (e.g., a “type” attribute such as the one included in Template Config Metadata 502 of FIG. 5). Looking up the template configuration file may include identifying, from various available template configuration files, a particular template configuration file that includes an identifier (e.g., via Template Config Metadata 502) that matches the value identified in the input configuration file at 1316.

At 1320, the Configuration Registry 1302 may return to the Configuration Resolver 1301 the identified input configuration file identified at 1314 and the template configuration file identified at 1318.

At 1321, the Configuration Resolver 1301 may be configured to validate the input configuration file and the template configuration file according to predefined validation rules. If the Configuration Resolver 1301 determines the input configuration file or the template configuration file is invalid, the request to render the page may be rejected and the method 1300 may cease. If the input and template configuration files are both valid, the Configuration Resolver 1301 may be configured to generate a merged configuration file (e.g., Merged Config 600 of FIG. 6) based at least in part on combining the input and template configuration files.

At 1322, the Configuration Resolver 1301 may transmit the merged configuration file to the Rendering Engine 1303.

At 1324, the Rendering Engine 1303 may identify data to be requested from the merged configuration file and may send (e.g., Model 904 of FIG, 9) one or more data requests to the Data Gateway 1304 (e.g., the Data Gateway 902 of FIG. 9). In some embodiments, the request(s) may be processed by the components depicted in FIG. 9.

At 1326, using the components depicted in FIG. 9, the Data Gateway 1304 may

transmit one or more data requests to one or more backend application programming interfaces (e.g., Backend APIs 1305, an example of the Backend APIs 914 of FIG. 9). In some embodiments, the requested data may be returned to Data Gateway 1304.

At 1328, Data Gateway 1304 may aggregate, format, transform, and/or store the data received from the Backend API(s) 1305 and may transmit the data to Rendering Engine 1303.

At 1330, Rendering Engine 1303 (e.g., Model 711) may store the data provided at 1328 (e.g., in Raw Data 718, a data store local to the Rendering Engine 708 of FIG. 7) and may generated materialized data which is sent to a View/Model component (e.g., View/Model 712 of FIG. 7) of the Rendering Engine 708. The View/Model component may be configured to store the materialized data (e.g., in Materialized Data 716 of FIG. 7, a data store configured to store such data).

At 1332, Rendering Engine 1303 may retrieve any suitable page-level data from Page-Level Data Store(s) 1307.

At 1334, Rendering Engine 1303 may retrieve any suitable App/User data from App/User Data Store(s) 1308).

At 1336, Rendering Engine 1303 may identify one or more components to be rendered on the page (e.g., from the template configuration file) and may transmit to Component Builder 1306 (e.g., Component Builder 804 of FIG. 8) any suitable combination of the page-level data, the App/User data, the template configuration file, or any suitable data corresponding to the component that is to be rendered at the page.

At 1338, Component Builder 804 may utilize any suitable combination of the data provided at 1336 to select a concrete component builder from a set of concrete component builders (e.g., Concrete Component Builders 808). The Component Builder 804 may invoke the functionality of the selected concrete component builder which in turn may instantiate a builder object (e.g., Builder 713 of FIG. 7) corresponding to the component to be rendered.

At 1340, Component Builder 804 may return the object instantiated by the selected concrete component builder to the Rendering Engine 1303.

At 1340, Rendering Engine 1303 may render the page utilizing the builder object provided at 1340 to render the component on the page.

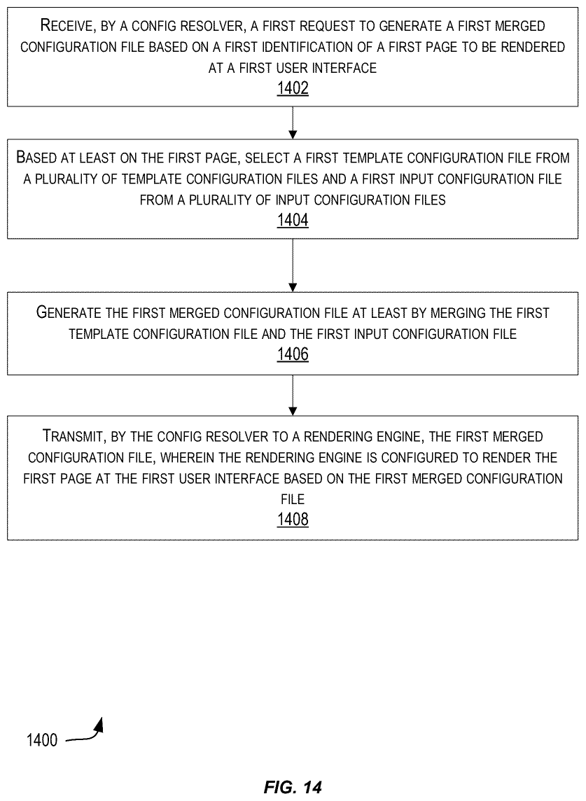

FIG. 14 is a block diagram illustrating an example method 1400, in accordance with at least one embodiment. Method 1400 may be performed by a console component (e.g., Rendering

Plugin 222 of FIG. 2) executed as part of a web application at a client device. In some embodiments, method 1400 may include more or fewer steps than the number depicted in FIG. 14. It should be appreciated that the steps of method 1400 may be performed in any suitable order.

Method 1400 may begin at 1402, where a config resolver (e.g., Configuration Resolver 212 of FIG. 2) may receive a first request to generate a first merged configuration file based on a first identification of a first page to be rendered at a first user interface.

At 1404, based at least on the first page, the config resolver may select a first template configuration file (e.g., Template Config 500 of FIG. 5) from a plurality of template configuration files and a first input configuration file (e.g., Input Config 400 of FIG. 4) from a plurality of input configuration files. In some embodiments, each of the plurality of template configuration files specifies (a) at least a portion of a respective page layout and (b) a respective set of one or more data placeholders (e.g., placeholder 508 of FIG. 5). In some embodiments, each of the plurality of input configuration files specifies at least one respective data value (e.g., data value 408 of FIG. 4) or respective data source for populating a respective set of data placeholders.

At 1406, the config resolver may generate the first merged configuration file (e.g., Merged Config 600 of FIG. 6) at least by merging the first template configuration file and the first input configuration file. In some embodiments, merging the first template configuration file and the first input configuration file comprises populating a first set of data placeholders (e.g., placeholder 508) specified in the first template configuration file based the at least one of data values (e.g., data value 408) or data sources specified in the first input configuration file.

At 1408, the config resolver may transmit to a rendering engine (e.g., Rendering Engine 218 of FIG. 2), the first merged configuration file. In some embodiments, the rendering engine is configured to render the first page at the first user interface based on the first merged configuration file.

Although not depicted, the method 1400 may further include 1) receiving, by the config resolver, a second request to generate a second merged configuration file based on a second identification of the first page to be rendered at a second user interface, 2) based at least on the first page, selecting, by the config resolver, a second template configuration file from the plurality of template configuration files and the first input configuration file from the plurality of input configuration files; wherein the first template configuration file specifies at least a portion of a first page layout, the second template configuration file specifies at least a portion of a second page layout, and wherein the portion of the first page layout and the portion of the second page layout are different; and 3) generating, by the config resolver, the second merged configuration file at least by merging the second template configuration file and the first input configuration file.

In some embodiments, the first template configuration file is associated with a first entity (e.g., a first cloud service team) and the second template config is associated with a second entity (e.g., a second cloud service team), and the first entity and the second entity are associated with at least one of different logos, different brand colors, different fonts. In some embodiments, the rendering engine is implemented by a first cloud service provider and the first entity and the second entity are a second cloud service provider and a third cloud servicer provider, respectively. In some embodiments, the first merged configuration file is used to render the first page for a first multi-cloud service offered by the first cloud service provider in partnership with the second cloud service provider. In some embodiments, the second merged configuration file is used to render the first page for a second multi-cloud service offered by the first cloud service provider in partnership with the third cloud service provider.

In some embodiments, the first template configuration file is associated with a first device form factor (e.g., a desktop device) and the second template configuration file is associated with a second device form factor (e.g., a mobile device) different than the first device form factor.

In some embodiments, the first merged configuration file generated based at least on the first template configuration file is to be rendered using a first framework (e.g., a first JavaScript library), and the second merged configuration file generated based at least on the second template configuration file is to be rendered using a second framework (e.g., a second JavaScript library that is different from the first JavaScript library).

In some embodiments, each of the plurality of template configuration files specifies a respective set of one or more layout placeholders. Each of the plurality of input configuration files may specify a respective layout value for populating a respective set of layout placeholders. In some embodiments, the layout placeholders comprise one or more of: 1) whether to enable breadcrumbs, 2) whether to use filters, 3) whether to include an action bar, 4) whether to include a table, 5) whether to use a horizontal arrangement of widgets, 6) whether to use a vertical arrangement of widgets, 7) a pagination of the horizontal arrangement or the vertical arrangement, 8) one or more row attributes of the horizontal arrangement, or 8) one or more column attributes of the vertical arrangement.

In some embodiments, the config resolver and the rendering engine are executed on a client side having the user interface the first request to generate the first merged configuration file is triggered responsive to receiving a request to render the first page at the first user interface.

In some embodiments, the config resolver is executed on a server side, the rendering engine is executed on a client side, and the first request to generate the first merged configuration file is triggered responsive to detecting an update to at least one of the first template configuration file or the first input config.

In some embodiments, the identification of the page comprises a URL.

In some embodiments, the plurality of template configuration files are maintained by a user interface service team, and the plurality of input configuration files are maintained by respective application teams.

In some embodiments, the plurality of template configuration files comprises a first version of the first template configuration file and a minor version with respect to the first version of the first template config. In some embodiments, the first input configuration file specifies an association with the first version of the first template config and the minor version with respect to the first version of the first template configuration file is backward-compatible with the first version of the first template configuration file such that the first input configuration file and the minor version with respect to the first version of the first template configuration file are mergeable to generate a second merged config.

In some embodiments, the config resolver may receive an updated template configuration file, the updated template configuration file providing an updated layout different than the first template configuration file. The config resolver may receive a subsequent request comprising the first identification of the first page to be rendered at the first user interface and generate a second merged configuration file at least by merging the updated template configuration file and the first input configuration file. The config resolver may transmit the second merged configuration file t the rendering engine, the rendering engine being configured to render the first page with the updated layout at the first user interface based on the second merged configuration file.

In some embodiments, the config resolver may validate the first input configuration file and the first template configuration file based at least in part on one or more validation rules. In some embodiments, validating the first input configuration file and the first template configuration file is performed at runtime.

In some embodiments, a shared model comprising contextual data and state data associated with the application is stored. In some embodiments, the shared model comprises at least one of a feature toggle, a user selection, a locale, a theme, a time zone, an active region, or an active compartment. In some embodiments the rendering engine is configured to render the first page based at least in part on the contextual data or the state data associated with the application.

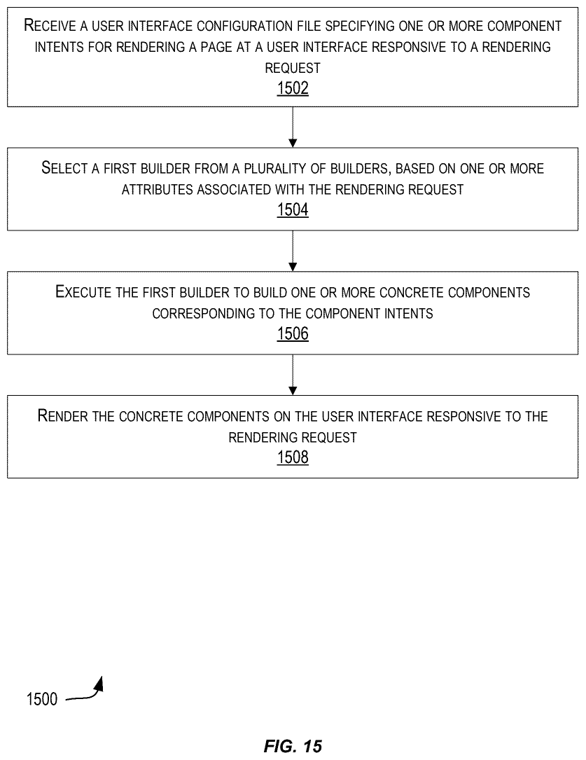

FIG. 15 is a block diagram illustrating an example method 1500, in accordance with at least one embodiment. Method 1500 may be performed by a console component executed as part of a web application or a software plugin at a client device. In some embodiments, method 1500 may include more or fewer steps than the number depicted in FIG. 15. It should be appreciated that the steps of method 1500 may be performed in any suitable order.

Method 1500 may begin at 1502, where a user interface configuration file (e.g., merged config 600 of FIG. 6) may be received by a console component (e.g., Configuration Builder 214 of FIG. 2). The merged configuration file may specify one or more component intents for rendering a page at a user interface responsive to a rendering request.

At 1504, a first builder may be selected by the console component from a plurality of builders (e.g., concrete component builders 808 of FIG. 8), based on one or more attributes associated with the rendering request (e.g., user data, device data, application data, an input configuration file, a web application at which the console component executes, etc.). In some embodiments, the plurality of builders are configured to build respective concrete components from different user interface (UI) component libraries. In some embodiments, the different UI component libraries specify respective sets of concrete components, and the different UI component libraries are associated with at least one of: different APIs for instantiating the respective sets of concrete components; different design languages; different implementation languages; and different web stacks. In some embodiments, the console component comprises a component builder that utilizes a common interface to interact with the plurality of builders. In some embodiments, the UI configuration file lacks a reference to the first builder of the plurality of builders.

At 1506, the console component may execute the first builder to build one or more concrete components (e.g., buttons, menus, radio buttons, edit boxes, or any suitable component of a user interface) corresponding to the component intents.

At 1508, the console component may render (e.g., via the Rendering Engine 218 of FIG. 2) the one or more concrete components on the user interface responsive to the rendering request.

In some embodiments, the console component selects the first builder from the plurality of builders is based at least in part on application-specific preferences that are accessible to the console component.

In some embodiments, the first builder implements a first framework comprising a first JavaScript library, and wherein a second builder of the plurality of builders implements a second framework comprising a second JavaScript library different than the first JavaScript library.

In some embodiments, a rendering engine of the console component invokes a component builder of the console component to select the first builder from the plurality of builders.

In some embodiments, the user interface configuration file is a merged configuration file that is generated by the console component from a template configuration file and an input configuration file, wherein the template configuration file specifies (a) at least a portion of a respective page layout and (b) a respective set of one or more data placeholders, and wherein the input configuration file specifies at least one respective data value or respective data source for populating a respective set of data placeholders.

In some embodiments, the first builder of the plurality of builders implements a first design of a particular concrete component and a second builder of the plurality of builders implements a second design of the particular concrete component.

In some embodiments, the first builder is selected based at least in part on application-specific data, and the method 1500 further comprises 1) replacing the application-specific data with updated application-specific data, 2) receiving, by the console component, the UI configuration file specifying the one or more component intents for rendering the page at the user interface responsive to a second rendering request, 3) selecting, by the console component, a second builder from the plurality of builders, based on the updated application-specific data, 4) executing, by the console component, the second builder to build at least one concrete component corresponding to the one or more component intents, and 5) rendering, by the console component, the at least one concrete component on the user interface responsive to the second rendering request.

In some embodiments, the first builder of the plurality of builders is implemented in a first programming language and a second builder of the plurality of builders is implemented in a second programming language different than the first programming language.

In some embodiments, the first builder of the plurality of builders utilizes a first web stack and a second builder of the plurality of builders, when selected, utilizes a second web stack.

In some embodiments, the first builder of the plurality of builders utilizes a first application programming interface to instantiate a respective set of concrete components and a second builder of the plurality of builders utilizes a second application programming interface different from the first application programming interface to instantiate the respective set of concrete components.

In some embodiments, the concrete components are rendered by a rendering engine of the console component, and the rendering engine invokes a component builder to select the first builder from the plurality of builders. The rendering engine may be free of dependencies on any of the plurality of builders. In some embodiments, the component builder implements a builder design pattern with the plurality of builders.

In some embodiments, the one or more concrete built using the first builder differ from corresponding concrete components built by a second builder of the plurality of builders by at least one of a color, a font, a shape, or a component type.

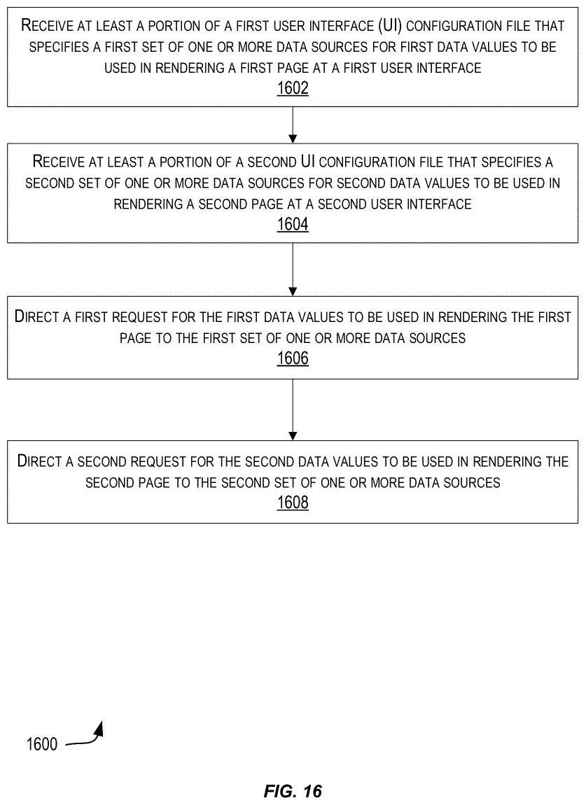

FIG. 16 is a block diagram illustrating an example method 1600, in accordance with at least one embodiment. Method 1600 may be performed by a console gateway (e.g., Data Gateway 220 of FIG. 2) executed as part of a web application at a client device. In some embodiments, method 1600 may include more or fewer steps than the number depicted in FIG. 16. It should be appreciated that the steps of method 1600 may be performed in any suitable order.

Method 1600 may begin at 1602, where a console gateway may receive at least a portion of a first user interface (UI) configuration file (e.g., Merged Config 600 of FIG. 6) that specifies a first set of one or more data sources for first data values to be used in rendering a first page at a first user interface.

At 1604, the console gateway may receive at least a portion of a second UI configuration file that specifies a second set of one or more data sources for second data values to be used in rendering a second page at a second user interface. In some embodiments, the console gateway serves as a common entry point for the first set of one or more data sources and the second set of one or more data sources. In some embodiments, the console gateway is configured to perform common functions for requests for data values to a plurality of data sources, the common functions comprising at least one of: authentication, authorization, logging, metrics generation, caching, data aggregation, data transformation, rate limiting, retry, or error handling. The console gateway may be configured to perform the common functions in a uniform fashion across the plurality of data sources.

At 1606, the console gateway may direct a first request for the first data values to be used in rendering the first page to the first set of one or more data sources.

At 1608, the console gateway may direct a second request for the second data values to be used in rendering the second page to the second set of one or more data sources.

In some embodiments, the console gateway is further configured to perform an application-specific function for a request for data values from a data source for rendering a particular page for a particular application. In some embodiments, the console gateway is configured to implement a centralized cache for a plurality of data sources, wherein implementing the centralized cache comprises 1) storing, by the console gateway at the centralized cache, the first data values obtained from the first set of one or more data sources for rendering the first page, and 2) retrieving, by the console gateway from the centralized cache, the first data values obtained for rendering the first page, the first data values being utilized to render a third page at a third user interface based on a third UI configuration file.

In some embodiments, the first UI configuration file specifies an application programming interface, and the first data values to be used in rendering the first page at the first user interface are requested by the console gateway using the application programming interface specified by the first UI configuration file.

In some embodiments, the console gateway transforms the first data values to be used in rendering the first page at the first user interface prior to the first data values being rendered at the first page at the first user interface. In some embodiments, the first data values are transformed according to a transformation rule specified by the first UI configuration file.

In some embodiments, the first data values are aggregated with additional data values obtained by the console gateway. The first data values may be aggregated with the additional data values based at least in part on an aggregation rule specified by the first UI configuration file.

In some embodiments, the console gateway may filter the first data values obtained by the console gateway. The first data values may be filtered based at least in part on filtering data specified in the first UI configuration file.

In some embodiments, the first UI configuration file comprises at least one of: an application programming interface with which the first data values may be obtained, a transformation rule for transforming the first data values obtained, an aggregation rule for aggregating the first data values with one or more additional data values, or filtering data defining a number of filters with which the first data values are filterable.

In some embodiments, the functionality of the console gateway is extended by one or more middleware components. The one or more middleware components may be provided by an application executing at a client device, the application being extended by a software plugin.

In some embodiments, the console gateway operates as a data access layer of a Model-View-ViewModel computing architecture and the console gateway is invoked by a model component of the Model-View-ViewModel computing architecture.

In some embodiments, the console gateway queues the first request and the second request and invokes a corresponding worker process to handle each queued request.

In some embodiments, performing a modification corresponding to functionality of the console gateway applies the modification for all subsequent requests.

In some embodiments, the console gateway instantiates a worker process, wherein the worker process is configured by the console gateway to perform at least one of: authentication, data transformation, data aggregation, pagination, caching, or retries. The console gateway may manage a lifecycle of the worker process.

In some embodiments, the console gate may 1) cache the first data values in a local cache, 2) determine that the second data values to be presented at the second user interface includes the first data values that are cached in the local cache, and 3) obtain, from the local cache, at least a portion of the second data values to be presented at the second user interface.

### IaaS Architecture Examples

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an laaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

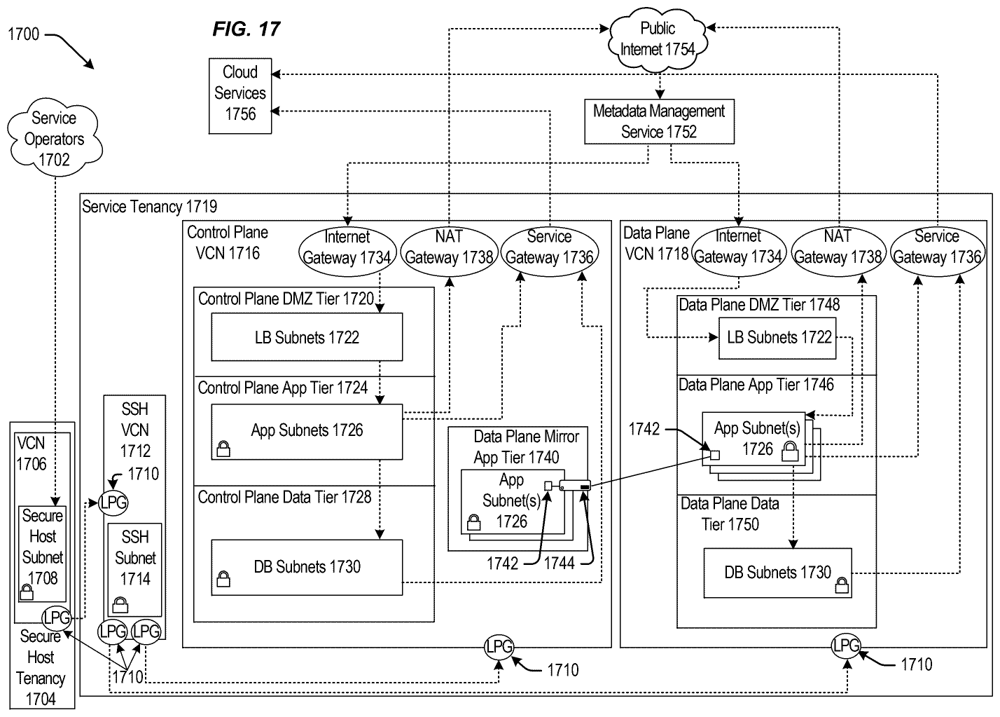

FIG. 17 is a block diagram 1700 illustrating an example pattern of an IaaS architecture, according to at least one embodiment. Service operators 1702 can be communicatively coupled to a secure host tenancy 1704 that can include a virtual cloud network (VCN) 1706 and a secure host subnet 1708. In some examples, the service operators 1702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1706 and/or the Internet.

The VCN 1706 can include a local peering gateway (LPG) 1710 that can be communicatively coupled to a secure shell (SSH) VCN 1712 via an LPG 1710 contained in the SSH VCN 1712. The SSH VCN 1712 can include an SSH subnet 1714, and the SSH VCN 1712 can be communicatively coupled to a control plane VCN 1716 via the LPG 1710 contained in the control plane VCN 1716. Also, the SSH VCN 1712 can be communicatively coupled to a data plane VCN 1718 via an LPG 1710. The control plane VCN 1716 and the data plane VCN 1718 can be contained in a service tenancy 1719 that can be owned and/or operated by the IaaS provider.

The control plane VCN 1716 can include a control plane demilitarized zone (DMZ) tier 1720 that acts as a perimeter network (e.g., portions of a corporate network between the corporate intranet and external networks). The DMZ-based servers may have restricted responsibilities and help keep breaches contained. Additionally, the DMZ tier 1720 can include one or more load balancer (LB) subnet(s) 1722, a control plane app tier 1724 that can include app subnet(s) 1726, a control plane data tier 1728 that can include database (DB) subnet(s) 1730 (e.g., frontend DB subnet(s) and/or backend DB subnet(s)). The LB subnet(s) 1722 contained in the control plane DMZ tier 1720 can be communicatively coupled to the app subnet(s) 1726 contained in the control plane app tier 1724 and an Internet gateway 1734 that can be contained in the control plane VCN 1716, and the app subnet(s) 1726 can be communicatively coupled to the DB subnet(s) 1730 contained in the control plane data tier 1728 and a service gateway 1736 and a network address translation (NAT) gateway 1738. The control plane VCN 1716 can include the service gateway 1736 and the NAT gateway 1738.

The control plane VCN 1716 can include a data plane mirror app tier 1740 that can include app subnet(s) 1726. The app subnet(s) 1726 contained in the data plane mirror app tier 1740 can include a virtual network interface controller (VNIC) 1742 that can execute a compute instance 1744. The compute instance 1744 can communicatively couple the app subnet(s) 1726 of the data plane mirror app tier 1740 to app subnet(s) 1726 that can be contained in a data plane app tier 1746.

The data plane VCN 1718 can include the data plane app tier 1746, a data plane DMZ tier 1748, and a data plane data tier 1750. The data plane DMZ tier 1748 can include LB subnet(s) 1722 that can be communicatively coupled to the app subnet(s) 1726 of the data plane app tier 1746 and the Internet gateway 1734 of the data plane VCN 1718. The app subnet(s) 1726 can be communicatively coupled to the service gateway 1736 of the data plane VCN 1718 and the NAT gateway 1738 of the data plane VCN 1718. The data plane data tier 1750 can also include the DB subnet(s) 1730 that can be communicatively coupled to the app subnet(s) 1726 of the data plane app tier 1746.

The Internet gateway 1734 of the control plane VCN 1716 and of the data plane VCN 1718 can be communicatively coupled to a metadata management service 1752 that can be communicatively coupled to public Internet 1754. Public Internet 1754 can be communicatively coupled to the NAT gateway 1738 of the control plane VCN 1716 and of the data plane VCN 1718. The service gateway 1736 of the control plane VCN 1716 and of the data plane VCN 1718 can be communicatively coupled to cloud services 1756.

In some examples, the service gateway 1736 of the control plane VCN 1716 or of the data plane VCN 1718 can make application programming interface (API) calls to cloud services 1756 without going through public Internet 1754. The API calls to cloud services 1756 from the service gateway 1736 can be one-way: the service gateway 1736 can make API calls to cloud services 1756, and cloud services 1756 can send requested data to the service gateway 1736. But, cloud services 1756 may not initiate API calls to the service gateway 1736.

In some examples, the secure host tenancy 1704 can be directly connected to the service tenancy 1719, which may be otherwise isolated. The secure host subnet 1708 can communicate with the SSH subnet 1714 through an LPG 1710 that may enable two-way communication over an otherwise isolated system. Connecting the secure host subnet 1708 to the SSH subnet 1714 may give the secure host subnet 1708 access to other entities within the service tenancy 1719.

The control plane VCN 1716 may allow users of the service tenancy 1719 to set up or otherwise provision desired resources. Desired resources provisioned in the control plane VCN 1716 may be deployed or otherwise used in the data plane VCN 1718. In some examples, the control plane VCN 1716 can be isolated from the data plane VCN 1718, and the data plane mirror app tier 1740 of the control plane VCN 1716 can communicate with the data plane app tier 1746 of the data plane VCN 1718 via VNICs 1742 that can be contained in the data plane mirror app tier 1740 and the data plane app tier 1746.

In some examples, users of the system, or customers, can make requests, for example create, read, update, or delete (CRUD) operations, through public Internet 1754 that can communicate the requests to the metadata management service 1752. The metadata management service 1752 can communicate the request to the control plane VCN 1716 through the Internet gateway 1734. The request can be received by the LB subnet(s) 1722 contained in the control plane DMZ tier 1720. The LB subnet(s) 1722 may determine that the request is valid, and in response to this determination, the LB subnet(s) 1722 can transmit the request to app subnet(s) 1726 contained in the control plane app tier 1724. If the request is validated and requires a call to public Internet 1754, the call to public Internet 1754 may be transmitted to the NAT gateway 1738 that can make the call to public Internet 1754. Metadata that may be desired to be stored by the request can be stored in the DB subnet(s) 1730.

In some examples, the data plane mirror app tier 1740 can facilitate direct communication between the control plane VCN 1716 and the data plane VCN 1718. For example, changes, updates, or other suitable modifications to configuration may be desired to be applied to the resources contained in the data plane VCN 1718. Via a VNIC 1742, the control plane VCN 1716 can directly communicate with, and can thereby execute the changes, updates, or other suitable modifications to configuration to, resources contained in the data plane VCN 1718.

In some embodiments, the control plane VCN 1716 and the data plane VCN 1718 can be contained in the service tenancy 1719. In this case, the user, or the customer, of the system may not own or operate either the control plane VCN 1716 or the data plane VCN 1718. Instead, the IaaS provider may own or operate the control plane VCN 1716 and the data plane VCN 1718, both of which may be contained in the service tenancy 1719. This embodiment can enable isolation of networks that may prevent users or customers from interacting with other users', or other customers', resources. Also, this embodiment may allow users or customers of the system to store databases privately without needing to rely on public Internet 1754, which may not have a desired level of threat prevention, for storage.

In other embodiments, the LB subnet(s) 1722 contained in the control plane VCN 1716 can be configured to receive a signal from the service gateway 1736. In this embodiment, the control plane VCN 1716 and the data plane VCN 1718 may be configured to be called by a customer of the IaaS provider without calling public Internet 1754. Customers of the IaaS provider may desire this embodiment since database(s) that the customers use may be controlled by the IaaS provider and may be stored on the service tenancy 1719, which may be isolated from public Internet 1754.

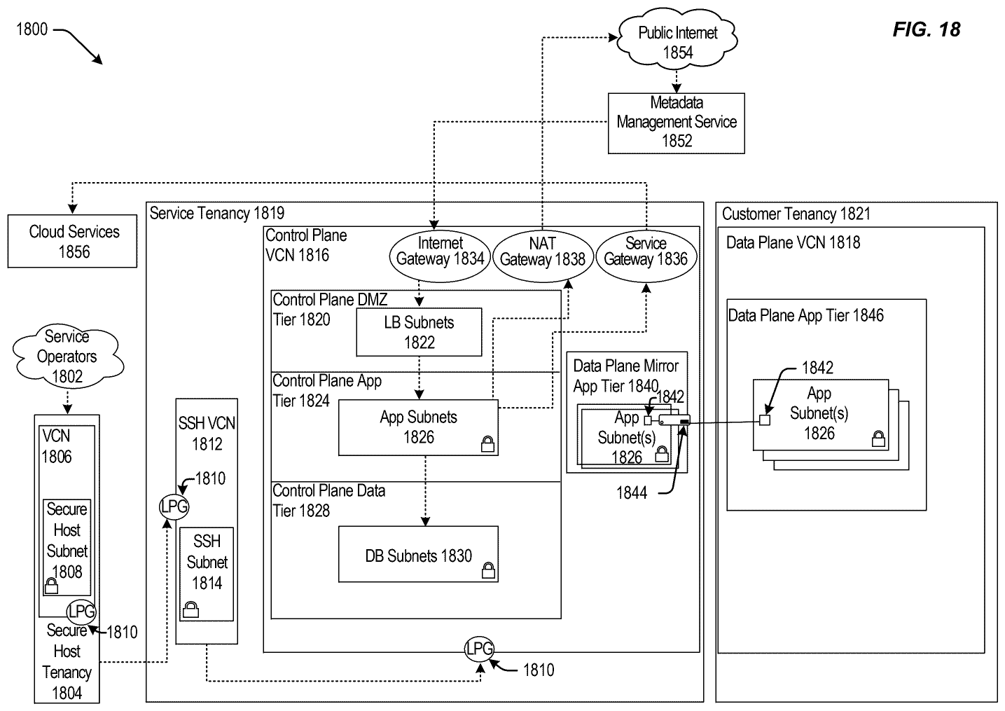

FIG. 18 is a block diagram 1800 illustrating another example pattern of an IaaS architecture, according to at least one embodiment. Service operators 1802 (e.g., service operators 1702 of FIG. 17) can be communicatively coupled to a secure host tenancy 1804 (e.g., the secure host tenancy 1704 of FIG. 17) that can include a virtual cloud network (VCN) 1806 (e.g., the VCN 1706 of FIG. 17) and a secure host subnet 1808 (e.g., the secure host subnet 1708 of FIG. 17). The VCN 1806 can include a local peering gateway (LPG) 1810 (e.g., the LPG 1710 of FIG. 17) that can be communicatively coupled to a secure shell (SSH) VCN 1812 (e.g., the SSH VCN 1712 of FIG. 17) via an LPG 1710 contained in the SSH VCN 1812. The SSH VCN 1812 can include an SSH subnet 1814 (e.g., the SSH subnet 1714 of FIG. 17), and the SSH VCN 1812 can be communicatively coupled to a control plane VCN 1816 (e.g., the control plane VCN 1716 of FIG. 17) via an LPG 1810 contained in the control plane VCN 1816. The control plane VCN 1816 can be contained in a service tenancy 1819 (e.g., the service tenancy 1719 of FIG. 17), and the data plane VCN 1818 (e.g., the data plane VCN 1718 of FIG. 17) can be contained in a customer tenancy 1821 that may be owned or operated by users, or customers, of the system.

The control plane VCN 1816 can include a control plane DMZ tier 1820 (e.g., the control plane DMZ tier 1720 of FIG. 17) that can include LB subnet(s) 1822 (e.g., LB subnet(s) 1722 of FIG. 17), a control plane app tier 1824 (e.g., the control plane app tier 1724 of FIG. 17) that can include app subnet(s) 1826 (e.g., app subnet(s) 1726 of FIG. 17), a control plane data tier 1828 (e.g., the control plane data tier 1728 of FIG. 17) that can include database (DB) subnet(s) 1830 (e.g., similar to DB subnet(s) 1730 of FIG. 17). The LB subnet(s) 1822 contained in the control plane DMZ tier 1820 can be communicatively coupled to the app subnet(s) 1826 contained in the control plane app tier 1824 and an Internet gateway 1834 (e.g., the Internet gateway 1734 of FIG. 17) that can be contained in the control plane VCN 1816, and the app subnet(s) 1826 can be communicatively coupled to the DB subnet(s) 1830 contained in the control plane data tier 1828 and a service gateway 1836 (e.g., the service gateway 1736 of FIG. 17) and a network address translation (NAT) gateway 1838 (e.g., the NAT gateway 1738 of FIG. 17). The control plane VCN 1816 can include the service gateway 1836 and the NAT gateway 1838.

The control plane VCN 1816 can include a data plane mirror app tier 1840 (e.g., the data plane mirror app tier 1740 of FIG. 17) that can include app subnet(s) 1826. The app subnet(s) 1826 contained in the data plane mirror app tier 1840 can include a virtual network interface controller (VNIC) 1842 (e.g., the VNIC of 1742) that can execute a compute instance 1844 (e.g., similar to the compute instance 1744 of FIG. 17). The compute instance 1844 can facilitate communication between the app subnet(s) 1826 of the data plane mirror app tier 1840 and the app subnet(s) 1826 that can be contained in a data plane app tier 1846 (e.g., the data plane app tier 1746 of FIG. 17) via the VNIC 1842 contained in the data plane mirror app tier 1840 and the VNIC 1842 contained in the data plane app tier 1846.

The Internet gateway 1834 contained in the control plane VCN 1816 can be communicatively coupled to a metadata management service 1852 (e.g., the metadata management service 1752 of FIG. 17) that can be communicatively coupled to public Internet 1854 (e.g., public Internet 1754 of FIG. 17). Public Internet 1854 can be communicatively coupled to the NAT gateway 1838 contained in the control plane VCN 1816. The service gateway 1836 contained in the control plane VCN 1816 can be communicatively coupled to cloud services 1856 (e.g., cloud services 1756 of FIG. 17).

In some examples, the data plane VCN 1818 can be contained in the customer tenancy 1821. In this case, the IaaS provider may provide the control plane VCN 1816 for each customer, and the IaaS provider may, for each customer, set up a unique compute instance 1844 that is contained in the service tenancy 1819. Each compute instance 1844 may allow communication between the control plane VCN 1816, contained in the service tenancy 1819, and the data plane VCN 1818 that is contained in the customer tenancy 1821. The compute instance 1844 may allow resources, that are provisioned in the control plane VCN 1816 that is contained in the service tenancy 1819, to be deployed or otherwise used in the data plane VCN 1818 that is contained in the customer tenancy 1821.

In other examples, the customer of the IaaS provider may have databases that live in the customer tenancy 1821. In this example, the control plane VCN 1816 can include the data plane mirror app tier 1840 that can include app subnet(s) 1826. The data plane mirror app tier 1840 can reside in the data plane VCN 1818, but the data plane mirror app tier 1840 may not live in the data plane VCN 1818. That is, the data plane mirror app tier 1840 may have access to the customer tenancy 1821, but the data plane mirror app tier 1840 may not exist in the data plane VCN 1818 or be owned or operated by the customer of the IaaS provider. The data plane mirror app tier 1840 may be configured to make calls to the data plane VCN 1818 but may not be configured to make calls to any entity contained in the control plane VCN 1816. The customer may desire to deploy or otherwise use resources in the data plane VCN 1818 that are provisioned in the control plane VCN 1816, and the data plane mirror app tier 1840 can facilitate the desired deployment, or other usage of resources, of the customer.

In some embodiments, the customer of the IaaS provider can apply filters to the data plane VCN 1818. In this embodiment, the customer can determine what the data plane VCN 1818 can access, and the customer may restrict access to public Internet 1854 from the data plane VCN 1818. The IaaS provider may not be able to apply filters or otherwise control access of the data plane VCN 1818 to any outside networks or databases. Applying filters and controls by the customer onto the data plane VCN 1818, contained in the customer tenancy 1821, can help isolate the data plane VCN 1818 from other customers and from public Internet 1854.

In some embodiments, cloud services 1856 can be called by the service gateway 1836 to access services that may not exist on public Internet 1854, on the control plane VCN 1816, or on the data plane VCN 1818. The connection between cloud services 1856 and the control plane VCN 1816 or the data plane VCN 1818 may not be live or continuous. Cloud services 1856 may exist on a different network owned or operated by the IaaS provider. Cloud services 1856 may be configured to receive calls from the service gateway 1836 and may be configured to not receive calls from public Internet 1854. Some cloud services 1856 may be isolated from other cloud services 1856, and the control plane VCN 1816 may be isolated from cloud services 1856 that may not be in the same region as the control plane VCN 1816. For example, the control plane VCN 1816 may be located in “Region 1,” and cloud service “Deployment 17,” may be located in Region 1 and in “Region 2.” If a call to Deployment 17 is made by the service gateway 1836 contained in the control plane VCN 1816 located in Region 1, the call may be transmitted to Deployment 17 in Region 1. In this example, the control plane VCN 1816, or Deployment 17 in Region 1, may not be communicatively coupled to, or otherwise in communication with, Deployment 17 in Region 2.

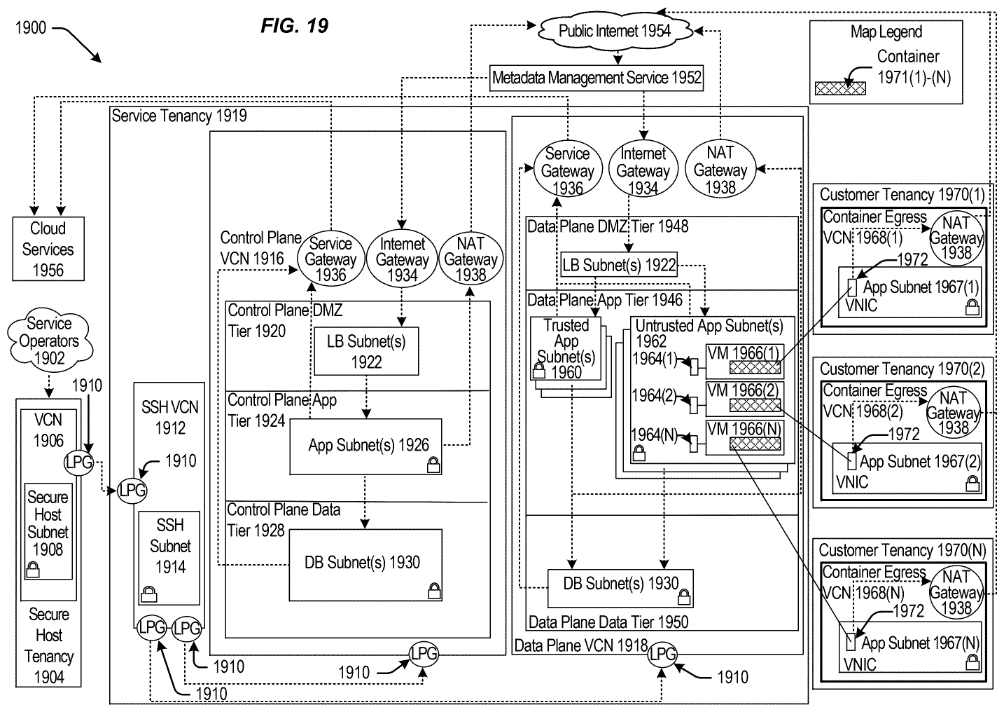

FIG. 19 is a block diagram 1900 illustrating another example pattern of an IaaS architecture, according to at least one embodiment. Service operators 1902 (e.g., service operators 1702 of FIG. 17) can be communicatively coupled to a secure host tenancy 1904 (e.g., the secure host tenancy 1704 of FIG. 17) that can include a virtual cloud network (VCN) 1906 (e.g., the VCN 1706 of FIG. 17) and a secure host subnet 1908 (e.g., the secure host subnet 1708 of FIG. 17). The VCN 1906 can include an LPG 1910 (e.g., the LPG 1710 of FIG. 17) that can be communicatively coupled to an SSH VCN 1912 (e.g., the SSH VCN 1712 of FIG. 17) via an LPG 1910 contained in the SSH VCN 1912. The SSH VCN 1912 can include an SSH subnet 1914 (e.g., the SSH subnet 1714 of FIG. 17), and the SSH VCN 1912 can be communicatively coupled to a control plane VCN 1916 (e.g., the control plane VCN 1716 of FIG. 17) via an LPG 1910 contained in the control plane VCN 1916 and to a data plane VCN 1918 (e.g., the data plane 1718 of FIG. 17) via an LPG 1910 contained in the data plane VCN 1918. The control plane VCN 1916 and the data plane VCN 1918 can be contained in a service tenancy 1919 (e.g., the service tenancy 1719 of FIG. 17).

The control plane VCN 1916 can include a control plane DMZ tier 1920 (e.g., the control plane DMZ tier 1720 of FIG. 17) that can include load balancer (LB) subnet(s) 1922 (e.g., LB subnet(s) 1722 of FIG. 17), a control plane app tier 1924 (e.g., the control plane app tier 1724 of FIG. 17) that can include app subnet(s) 1926 (e.g., similar to app subnet(s) 1726 of FIG. 17), a control plane data tier 1928 (e.g., the control plane data tier 1728 of FIG. 17) that can include DB subnet(s) 1930. The LB subnet(s) 1922 contained in the control plane DMZ tier 1920 can be communicatively coupled to the app subnet(s) 1926 contained in the control plane app tier 1924 and to an Internet gateway 1934 (e.g., the Internet gateway 1734 of FIG. 17) that can be contained in the control plane VCN 1916, and the app subnet(s) 1926 can be communicatively coupled to the DB subnet(s) 1930 contained in the control plane data tier 1928 and to a service gateway 1936 (e.g., the service gateway of FIG. 17) and a network address translation (NAT) gateway 1938 (e.g., the NAT gateway 1738 of FIG. 17). The control plane VCN 1916 can include the service gateway 1936 and the NAT gateway 1938.

The data plane VCN 1918 can include a data plane app tier 1946 (e.g., the data plane app tier 1746 of FIG. 17), a data plane DMZ tier 1948 (e.g., the data plane DMZ tier 1748 of FIG. 17), and a data plane data tier 1950 (e.g., the data plane data tier 1750 of FIG. 17). The data plane DMZ tier 1948 can include LB subnet(s) 1922 that can be communicatively coupled to trusted app subnet(s) 1960 and untrusted app subnet(s) 1962 of the data plane app tier 1946 and the Internet gateway 1934 contained in the data plane VCN 1918. The trusted app subnet(s) 1960 can be communicatively coupled to the service gateway 1936 contained in the data plane VCN 1918, the NAT gateway 1938 contained in the data plane VCN 1918, and DB subnet(s) 1930 contained in the data plane data tier 1950. The untrusted app subnet(s) 1962 can be communicatively coupled to the service gateway 1936 contained in the data plane VCN 1918 and DB subnet(s) 1930 contained in the data plane data tier 1950. The data plane data tier 1950 can include DB subnet(s) 1930 that can be communicatively coupled to the service gateway 1936 contained in the data plane VCN 1918.

The untrusted app subnet(s) 1962 can include one or more primary VNICs 1964(1)-(N) that can be communicatively coupled to tenant virtual machines (VMs) 1966(1)-(N). Each tenant VM 1966(1)-(N) can be communicatively coupled to a respective app subnet 1967(1)-(N) that can be contained in respective container egress VCNs 1968(1)-(N) that can be contained in respective customer tenancies 1970(1)-(N). Respective secondary VNICs 1972(1)-(N) can facilitate communication between the untrusted app subnet(s) 1962 contained in the data plane VCN 1918 and the app subnet contained in the container egress VCNs 1968(1)-(N). Each container egress VCNs 1968(1)-(N) can include a NAT gateway 1938 that can be communicatively coupled to public Internet 1954 (e.g., public Internet 1754 of FIG. 17).

The Internet gateway 1934 contained in the control plane VCN 1916 and contained in the data plane VCN 1918 can be communicatively coupled to a metadata management service 1952 (e.g., the metadata management system 1752 of FIG. 17) that can be communicatively coupled to public Internet 1954. Public Internet 1954 can be communicatively coupled to the NAT gateway 1938 contained in the control plane VCN 1916 and contained in the data plane VCN 1918. The service gateway 1936 contained in the control plane VCN 1916 and contained in the data plane VCN 1918 can be communicatively coupled to cloud services 1956.

In some embodiments, the data plane VCN 1918 can be integrated with customer tenancies 1970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1946. Code to run the function may be executed in the VMs 1966(1)-(N), and the code may not be configured to run anywhere else on the data plane VCN 1918. Each VM 1966(1)-(N) may be connected to one customer tenancy 1970. Respective containers 1971(1)-(N) contained in the VMs 1966(1)-(N) may be configured to run the code. In this case, there can be a dual isolation (e.g., the containers 1971(1)-(N) running code, where the containers 1971(1)-(N) may be contained in at least the VM 1966(1)-(N) that are contained in the untrusted app subnet(s) 1962), which may help prevent incorrect or otherwise undesirable code from damaging the network of the IaaS provider or from damaging a network of a different customer. The containers 1971(1)-(N) may be communicatively coupled to the customer tenancy 1970 and may be configured to transmit or receive data from the customer tenancy 1970. The containers 1971(1)-(N) may not be configured to transmit or receive data from any other entity in the data plane VCN 1918. Upon completion of running the code, the IaaS provider may kill or otherwise dispose of the containers 1971(1)-(N).

In some embodiments, the trusted app subnet(s) 1960 may run code that may be owned or operated by the IaaS provider. In this embodiment, the trusted app subnet(s) 1960 may be communicatively coupled to the DB subnet(s) 1930 and be configured to execute CRUD operations in the DB subnet(s) 1930. The untrusted app subnet(s) 1962 may be communicatively coupled to the DB subnet(s) 1930, but in this embodiment, the untrusted app subnet(s) may be configured to execute read operations in the DB subnet(s) 1930. The containers 1971(1)-(N) that can be contained in the VM 1966(1)-(N) of each customer and that may run code from the customer may not be communicatively coupled with the DB subnet(s) 1930.

In other embodiments, the control plane VCN 1916 and the data plane VCN 1918 may not be directly communicatively coupled. In this embodiment, there may be no direct communication between the control plane VCN 1916 and the data plane VCN 1918. However, communication can occur indirectly through at least one method. An LPG 1910 may be established by the IaaS provider that can facilitate communication between the control plane VCN 1916 and the data plane VCN 1918. In another example, the control plane VCN 1916 or the data plane VCN 1918 can make a call to cloud services 1956 via the service gateway 1936. For example, a call to cloud services 1956 from the control plane VCN 1916 can include a request for a service that can communicate with the data plane VCN 1918.

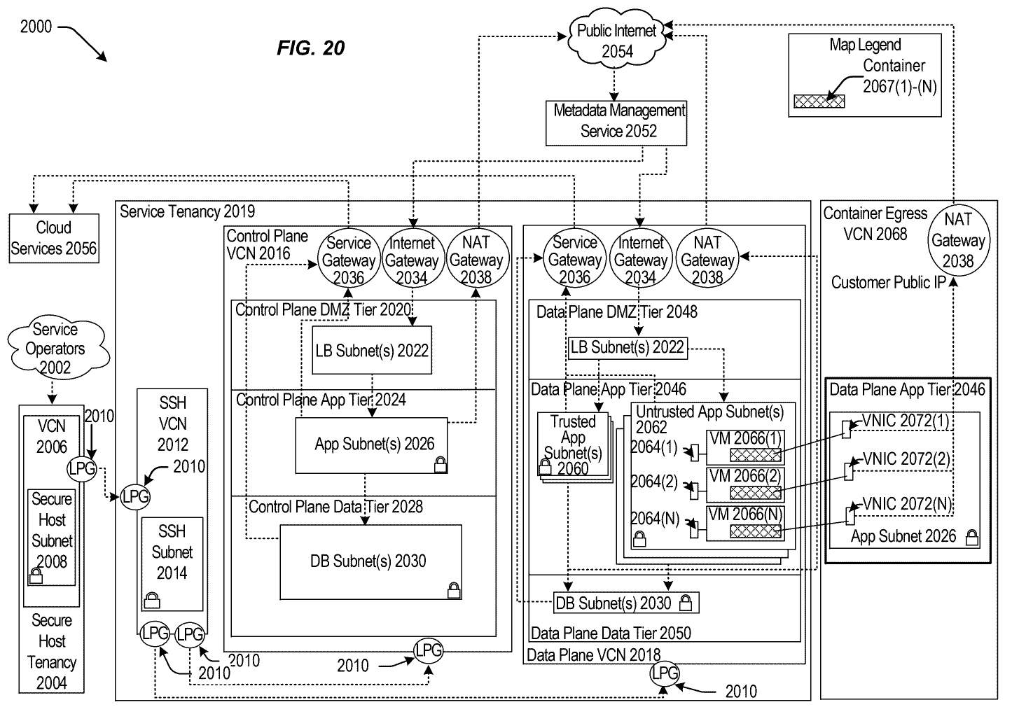

FIG. 20 is a block diagram 2000 illustrating another example pattern of an IaaS architecture, according to at least one embodiment. Service operators 2002 (e.g., service operators 1702 of FIG. 17) can be communicatively coupled to a secure host tenancy 2004 (e.g., the secure host tenancy 1704 of FIG. 17) that can include a virtual cloud network (VCN) 2006 (e.g., the VCN 1706 of FIG. 17) and a secure host subnet 2008 (e.g., the secure host subnet 1708 of FIG. 17). The VCN 2006 can include an LPG 2010 (e.g., the LPG 1710 of FIG. 17) that can be communicatively coupled to an SSH VCN 2012 (e.g., the SSH VCN 1712 of FIG. 17) via an LPG 2010 contained in the SSH VCN 2012. The SSH VCN 2012 can include an SSH subnet 2014 (e.g., the SSH subnet 1714 of FIG. 17), and the SSH VCN 2012 can be communicatively coupled to a control plane VCN 2016 (e.g., the control plane VCN 1716 of FIG. 17) via an LPG 2010 contained in the control plane VCN 2016 and to a data plane VCN 2018 (e.g., the data plane 1718 of FIG. 17) via an LPG 2010 contained in the data plane VCN 2018. The control plane VCN 2016 and the data plane VCN 2018 can be contained in a service tenancy 2019 (e.g., the service tenancy 1719 of FIG. 17).

The control plane VCN 2016 can include a control plane DMZ tier 2020 (e.g., the control plane DMZ tier 1720 of FIG. 17) that can include LB subnet(s) 2022 (e.g., LB subnet(s) 1722 of FIG. 17), a control plane app tier 2024 (e.g., the control plane app tier 1724 of FIG. 17) that can include app subnet(s) 2026 (e.g., app subnet(s) 1726 of FIG. 17), a control plane data tier 2028 (e.g., the control plane data tier 1728 of FIG. 17) that can include DB subnet(s) 2030 (e.g., DB subnet(s) 1930 of FIG. 19). The LB subnet(s) 2022 contained in the control plane DMZ tier 2020 can be communicatively coupled to the app subnet(s) 2026 contained in the control plane app tier 2024 and to an Internet gateway 2034 (e.g., the Internet gateway 1734 of FIG. 17) that can be contained in the control plane VCN 2016, and the app subnet(s) 2026 can be communicatively coupled to the DB subnet(s) 2030 contained in the control plane data tier 2028 and to a service gateway 2036 (e.g., the service gateway of FIG. 17) and a network address translation (NAT) gateway 2038 (e.g., the NAT gateway 1738 of FIG. 17). The control plane VCN 2016 can include the service gateway 2036 and the NAT gateway 2038.

The data plane VCN 2018 can include a data plane app tier 2046 (e.g., the data plane app tier 1746 of FIG. 17), a data plane DMZ tier 2048 (e.g., the data plane DMZ tier 1748 of FIG.

17), and a data plane data tier 2050 (e.g., the data plane data tier 1750 of FIG. 17). The data plane DMZ tier 2048 can include LB subnet(s) 2022 that can be communicatively coupled to trusted app subnet(s) 2060 (e.g., trusted app subnet(s) 1960 of FIG. 19) and untrusted app subnet(s) 2062 (e.g., untrusted app subnet(s) 1962 of FIG. 19) of the data plane app tier 2046 and the Internet gateway 2034 contained in the data plane VCN 2018. The trusted app subnet(s) 2060 can be communicatively coupled to the service gateway 2036 contained in the data plane VCN 2018, the NAT gateway 2038 contained in the data plane VCN 2018, and DB subnet(s) 2030 contained in the data plane data tier 2050. The untrusted app subnet(s) 2062 can be communicatively coupled to the service gateway 2036 contained in the data plane VCN 2018 and DB subnet(s) 2030 contained in the data plane data tier 2050. The data plane data tier 2050 can include DB subnet(s) 2030 that can be communicatively coupled to the service gateway 2036 contained in the data plane VCN 2018.

The untrusted app subnet(s) 2062 can include primary VNICs 2064(1)-(N) that can be communicatively coupled to tenant virtual machines (VMs) 2066(1)-(N) residing within the untrusted app subnet(s) 2062. Each tenant VM 2066(1)-(N) can run code in a respective container 2067(1)-(N), and be communicatively coupled to an app subnet 2026 that can be contained in a data plane app tier 2046 that can be contained in a container egress VCN 2068. Respective secondary VNICs 2072(1)-(N) can facilitate communication between the untrusted app subnet(s) 2062 contained in the data plane VCN 2018 and the app subnet contained in the container egress VCN 2068. The container egress VCN can include a NAT gateway 2038 that can be communicatively coupled to public Internet 2054 (e.g., public Internet 1754 of FIG. 17).

The Internet gateway 2034 contained in the control plane VCN 2016 and contained in the data plane VCN 2018 can be communicatively coupled to a metadata management service 2052 (e.g., the metadata management system 1752 of FIG. 17) that can be communicatively coupled to public Internet 2054. Public Internet 2054 can be communicatively coupled to the NAT gateway 2038 contained in the control plane VCN 2016 and contained in the data plane VCN 2018. The service gateway 2036 contained in the control plane VCN 2016 and contained in the data plane VCN 2018 can be communicatively coupled to cloud services 2056.

In some examples, the pattern illustrated by the architecture of block diagram 2000 of FIG. 20 may be considered an exception to the pattern illustrated by the architecture of block diagram 1900 of FIG. 19 and may be desirable for a customer of the IaaS provider if the IaaS provider cannot directly communicate with the customer (e.g., a disconnected region). The respective containers 2067(1)-(N) that are contained in the VMs 2066(1)-(N) for each customer can be accessed in real-time by the customer. The containers 2067(1)-(N) may be configured to make calls to respective secondary VNICs 2072(1)-(N) contained in app subnet(s) 2026 of the data plane app tier 2046 that can be contained in the container egress VCN 2068. The secondary VNICs 2072(1)-(N) can transmit the calls to the NAT gateway 2038 that may transmit the calls to public Internet 2054. In this example, the containers 2067(1)-(N) that can be accessed in real-time by the customer can be isolated from the control plane VCN 2016 and can be isolated from other entities contained in the data plane VCN 2018. The containers 2067(1)-(N) may also be isolated from resources from other customers.

In other examples, the customer can use the containers 2067(1)-(N) to call cloud services 2056. In this example, the customer may run code in the containers 2067(1)-(N) that requests a service from cloud services 2056. The containers 2067(1)-(N) can transmit this request to the secondary VNICs 2072(1)-(N) that can transmit the request to the NAT gateway that can transmit the request to public Internet 2054. Public Internet 2054 can transmit the request to LB subnet(s) 2022 contained in the control plane VCN 2016 via the Internet gateway 2034. In response to determining the request is valid, the LB subnet(s) can transmit the request to app subnet(s) 2026 that can transmit the request to cloud services 2056 via the service gateway 2036.

It should be appreciated that IaaS architectures 1700, 1800, 1900, 2000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

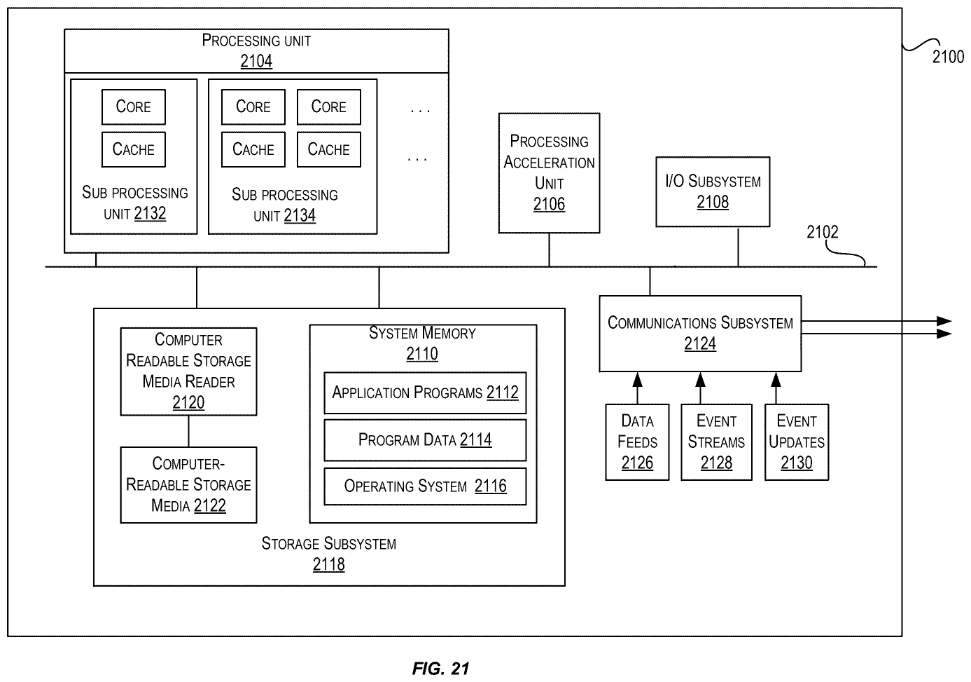

FIG. 21 illustrates an example computer system 2100, in which various embodiments may be implemented. The system 2100 may be used to implement any of the computer systems described above. As shown in the figure, computer system 2100 includes a processing unit 2104 that communicates with a number of peripheral subsystems via a bus subsystem 2102. These peripheral subsystems may include a processing acceleration unit 2106, an I/O subsystem 2108, a storage subsystem 2118 and a communications subsystem 2124. Storage subsystem 2118 includes tangible computer-readable storage media 2122 and a system memory 2110.

Bus subsystem 2102 provides a mechanism for letting the various components and subsystems of computer system 2100 communicate with each other as intended. Although bus subsystem 2102 is shown schematically as a single bus, alternative embodiments of the bus subsystem may utilize multiple buses. Bus subsystem 2102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2104, which can be implemented as one or more integrated circuits (e.g., a conventional microprocessor or microcontroller), controls the operation of computer system 2100. One or more processors may be included in processing unit 2104. These processors may include single core or multicore processors. In certain embodiments, processing unit 2104 may be implemented as one or more independent processing units 2132 and/or 2134 with single or multicore processors included in each processing unit. In other embodiments, processing unit 2104 may also be implemented as a quad-core processing unit formed by integrating two dual-core processors into a single chip.

In various embodiments, processing unit 2104 can execute a variety of programs in response to program code and can maintain multiple concurrently executing programs or processes. At any given time, some or all of the program code to be executed can be resident in processor(s) 2104 and/or in storage subsystem 2118. Through suitable programming, processor(s) 2104 can provide various functionalities described above. Computer system 2100 may additionally include a processing acceleration unit 2106, which can include a digital signal processor (DSP), a special-purpose processor, and/or the like.

I/O subsystem 2108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2100 may comprise a storage subsystem 2118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2104 provide the functionality described above. Storage subsystem 2118 may also provide a repository for storing data used in accordance with the present disclosure.

As depicted in the example in FIG. 21, storage subsystem 2118 can include various components including a system memory 2110, computer-readable storage media 2122, and a computer readable storage media reader 2120. System memory 2110 may store program instructions that are loadable and executable by processing unit 2104. System memory 2110 may also store data that is used during the execution of the instructions and/or data that is generated during the execution of the program instructions. Various different kinds of programs may be loaded into system memory 2110 including but not limited to client applications, Web browsers, mid-tier applications, relational database management systems (RDBMS), virtual machines, containers, etc.

System memory 2110 may also store an operating system 2116. Examples of operating system 2116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2100 executes one or more virtual machines, the virtual machines along with their guest operating systems (GOSs) may be loaded into system memory 2110 and executed by one or more processors or cores of processing unit 2104.

System memory 2110 can come in different configurations depending upon the type of computer system 2100. For example, system memory 2110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2110 may include a basic input/output system (BIOS) containing basic routines that help to transfer information between elements within computer system 2100, such as during start-up.

Computer-readable storage media 2122 may represent remote, local, fixed, and/or removable storage devices plus storage media for temporarily and/or more permanently containing, storing, computer-readable information for use by computer system 2100 including instructions executable by processing unit 2104 of computer system 2100.

Computer-readable storage media 2122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2122 may include, but is not limited to, Zip® drives, flash memory cards, universal serial bus (USB) flash drives, secure digital (SD) cards, DVD disks, digital video tape, and the like. Computer-readable storage media 2122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2100.

Machine-readable instructions executable by one or more processors or cores of processing unit 2104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2124 provides an interface to other computer systems and networks. Communications subsystem 2124 serves as an interface for receiving data from and transmitting data to other systems from computer system 2100. For example, communications subsystem 2124 may enable computer system 2100 to connect to one or more devices via the Internet. In some embodiments communications subsystem 2124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2124 can provide wired network connectivity (e.g., Ethernet) in addition to or instead of a wireless interface.

In some embodiments, communications subsystem 2124 may also receive input communication in the form of structured and/or unstructured data feeds 2126, event streams 2128, event updates 2130, and the like on behalf of one or more users who may use computer system 2100.

By way of example, communications subsystem 2124 may be configured to receive data feeds 2126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2124 may also be configured to receive data in the form of continuous data streams, which may include event streams 2128 of real-time events and/or event updates 2130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2124 may also be configured to output the structured and/or unstructured data feeds 2126, event streams 2128, event updates 2130, and the like to one or more databases that may be in communication with one or more streaming data source computers coupled to computer system 2100.

Computer system 2100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a console gateway, at least a portion of a first user interface (UI) configuration file that specifies a first set of one or more data sources for first data values to be used in rendering a first page at a first user interface;
receiving, by the console gateway, at least a portion of a second UI configuration file that specifies a second set of one or more data sources for second data values to be used in rendering a second page at a second user interface;
wherein the console gateway serves as a common entry point for the first set of one or more data sources and the second set of one or more data sources;
directing, by the console gateway, a first request for the first data values to be used in rendering the first page to the first set of one or more data sources; and
directing, by the console gateway, a second request for the second data values to be used in rendering the second page to the second set of one or more data sources.

2. The method of claim 1, wherein the console gateway is configured to perform common functions for requests for data values to a plurality of data sources, the common functions comprising at least one of:
authentication;
authorization;
logging;
metrics generation;
caching;
data aggregation;
data transformation;
rate limiting;
retry; or
error handling.

3. The method of claim 2, wherein the console gateway is configured to perform the common functions in a uniform fashion across the plurality of data sources.

4. The method of claim 2, wherein the console gateway is further configured to perform an application-specific function for a request for data values from a data source for rendering a particular page for a particular application.

5. The method of claim 1, wherein the console gateway is configured to implement a centralized cache for a plurality of data sources, wherein implementing the centralized cache comprises:
storing, by the console gateway at the centralized cache, the first data values obtained from the first set of one or more data sources for rendering the first page; and
retrieving, by the console gateway from the centralized cache, the first data values obtained for rendering the first page, the first data values being used to render a third page at a third user interface based on a third UI configuration file.

6. The method of claim 1, wherein the first UI configuration file specifies an application programming interface, and wherein the first data values to be used in rendering the first page at the first user interface are requested by the console gateway using the application programming interface specified by the first UI configuration file.

7. The method of claim 1, wherein the console gateway transforms the first data values to be used in rendering the first page at the first user interface prior to the first data values being rendered at the first page at the first user interface, wherein the first data values are transformed according to a transformation rule specified by the first UI configuration file.

8. The method of claim 1, wherein the first data values are aggregated with additional data values obtained by the console gateway, wherein the first data values are aggregated with the additional data values based at least in part on an aggregation rule specified by the first UI configuration file.

9. The method of claim 1, further comprising filtering, by the console gateway, the first data values obtained by the console gateway, wherein the first data values are filtered based at least in part on filtering data specified in the first UI configuration file.

10. The method of claim 1, wherein the first UI configuration file comprises at least one of: an application programming interface with which the first data values may be obtained, a transformation rule for transforming the first data values obtained, an aggregation rule for aggregating the first data values with one or more additional data values, or filtering data defining a number of filters with which the first data values are filterable.

11. The method of claim 1, wherein functionality of the console gateway is extended by one or more middleware components.

12. The method of claim 11, wherein the one or more middleware components are provided by an application executing at a client device, the application being extended by a software plugin.

13. The method of claim 1, wherein the console gateway operates as a data access layer of a Model-View-ViewModel computing architecture.

14. The method of claim 13, wherein the console gateway is invoked by a model component of the Model-View-ViewModel computing architecture.

15. A console gateway, comprising:
one or more processors; and
one or more memories storing computer-executable instructions that, when executed by the one or more processors, cause the one or more processors of the console gateway to:
receive at least a portion of a first user interface (UI) configuration file that specifies a first set of one or more data sources for first data values to be used in rendering a first page at a first user interface;
receive at least a portion of a second UI configuration file that specifies a second set of one or more data sources for second data values to be used in rendering a second page at a second user interface;
wherein the console gateway serves as a common entry point for the first set of one or more data sources and the second set of one or more data sources;
direct a first request for the first data values to be used in rendering the first page to the first set of one or more data sources; and
direct a second request for the second data values to be used in rendering the second page to the second set of one or more data sources.

16. The console gateway of claim 15, wherein the console gateway queues the first request and the second request and invokes a corresponding worker process to handle each queued request.

17. The console gateway of claim 15, wherein performing a modification corresponding to functionality of the console gateway applies the modification for all subsequent requests.

18. The console gateway of claim 15, wherein the console gateway instantiates a worker process, and wherein the worker process is configured by the console gateway to perform at least one of: authentication, data transformation, data aggregation, pagination, caching, or retries.

19. The console gateway of claim 18, wherein the console gateway manages a lifecycle of the worker process.

20. The console gateway of claim 15, wherein executing the computer-executable instructions causes the one or more processors to:
cache the first data values in a local cache;
determine, by the console gateway, that the second data values to be presented at the second user interface includes the first data values that are cached in the local cache; and
obtain, by the console gateway from the local cache, at least a portion of the second data values to be presented at the second user interface.
